(19) United States
(12) Patent Application Publication
(10) Pub. No.: US 2007/0174471 A1
(43) Pub. Date: Jul. 26, 2007

(54) Secure, continous, proxy-optimized, device-to-device data download reception system and method of use

(76) Inventor: Cedric Van Rossum, Hacienda Heights, CA (US)

Correspondence Address: IPTV SYSTEMS, LLC, RCM # 6152, 1425 SW MILIKAN WAY, BEAVERTON, OR, 97005-2343, US

(21) Appl. No.: 10/555,348

(22) PCT Filed: Apr. 28, 2004
(86) PCT No.: PCT/US04/13090

§ 371 Date: Oct. 31, 2005

Related U.S. Application Data
(60) Provisional application No. 60/467,271, filed on Apr. 30, 2003.
(60) Provisional application No. 60/528,088, filed on Dec. 9, 2003.

(51) Int. Cl. G06F 15/16

(52) U.S. Cl. 709/229

(57) ABSTRACT

The current invention comprises a digital Data Download Reception unit (DDR unit) used to download data files over an electronic network (or equivalent) and the method for using the DDR unit system for delivering on-demand or near on-demand multimedia services.

The present application claims benefit of priority to U.S. Provisional Patent Application Ser. No. 60/528,088 filed Dec. 9, 2003, entitled “Secure, Continuous, Proxy-Optimized, Device-to-Device Data Download Reception System and Method of Uses,” and U.S. Provisional Patent Application Ser. No. 60/467,271 filed Apr. 30, 2003, entitled, “Secure, Continuous, Device-to-device Data Download Reception System and Method of Use,” both naming Cedric Van Rossum as inventor; each of which is incorporated by reference in its entirety.

This application incorporates by reference Disclosure Document No. 529804, entitled “Secure, continuous, device-to-device data download reception unit and method of using it for multimedia-on-demand services and TV over network,” received by the United States Patent and Trademark Office on Apr. 17, 2003.

### BACKGROUND

The sales and distribution of multimedia data, such as music or video, is a complicated business model: the data must be stored on a digital media, the media has to be reproduced a large number of time without loss of quality, and it finally has to be shipped to multiple distributors to be sold in retail stores. This results in significant expenses in logistics and inventories for the content providers, especially since there are many different distribution channels and many new titles released on a regular basis.

The availability of the Internet enables new methods of directly distributing multimedia files to end-users in an electronic format. The advantages associated with electronic distribution are pushing providers of content to establish global distribution systems for digital content.

At the same time, consumer demand for easily accessible and reasonably priced digital entertainment is growing.

Along with this opportunity, however, comes the risk of illegal distribution. In order to reduce this risk, content must be protected throughout the distribution and consumption process. Digital Right Management is a technology that provides this kind of copyright protection.

The availability of new compression algorithms for multimedia data has dramatically reduced the bandwidth and storage space required for the electronic distribution of these data. It enables a more efficient distribution of the data, and at a higher definition, but also facilitates illegal distribution.

Unregulated PC-based file-sharing networks that share pirated music and video have their genesis in Napster. The Napster system has been closed due to unresolved copyright infringement issues. Other file-sharing networks exist today using programs like KaZaa, Morpheus, or Gnutella. Millions of illegal files are transferred every month, causing significant prejudice to the content owner companies since these files can be distributed very quickly without any way for the entertainment industry to filter, control, or stop this phenomenon.

The current infrastructure to provide real-time, streaming, on-demand multimedia services to households is expensive, requires significant changes in the hardware systems of the operators, and has been slow to be put in place.

The current Multimedia-On-Demand (MoD) services—provided over cable or satellite—require significant bandwidth and are still perceived by the consumers as fairly inconvenient, such as the necessity of special costly receivers, and movies only starting at specific times.

Many companies providing Video-On-Demand (VoD) services over the Internet have experienced a limited success on the market. The quality of the multimedia files delivered to users can be poor and many users are not interested in watching these files on computer screen.

The availability of numerous music-on-demand providers on the Internet has changed the behavior of the consumers. They now want to have an active ownership of the multimedia files they want to listen to; and they want to have the ability to choose multimedia files in a broad electronic catalog to then download them on their PC (or portable music player) in the format they have chosen. This is a clear dislocation for the entertainment industry since these users were previously only “passive” individuals who had no or little choice on the programs they were listening to (e.g. radio). The same trend will likely occur with television in the future when more users will start selecting more carefully the programs they desire to watch.

Several Movie on-demand services are available today (e.g. digital cable) but they do not offer good selection tools to the user. The user has access to numerous different titles but the choice in the movie library is difficult, never customized, and limited to a small number of titles in comparison to all the titles released by movie studios every year.

The PC users who want to transfer large files over a network, and only have access—most of the time—to a relatively limited bandwidth, have no other choice than leaving their computers turned on for a long time. This results in leaving the computer vulnerable to external attacks from the network, especially when the machine is left without surveillance during the period of transfer.

The importance of the problem described above has recently increased due to the availability of many new spy-ware programs on the Internet. This trend has also been seen with many file-sharing or file transfer programs that had hidden backdoors, or were using ad-ware features in an exaggerated way. The consequence of these problems is a growing, uncomfortable, feeling of anxiety and frustration for the users of these programs.

The penetration of Video-on-Demand is below 5% today and is not projected to reach 30% until 2005. VoD is still perceived by the majority of the US households as something many years away.

MP3 players have been one of the most popular personal consumer electronics applications in the last 2 years, with sales over 3.5 million units forecasted for 2003. The success of these portable multimedia players will push consumers to migrate to portable video players in the future.

The capacity of storage devices like hard-drives will keep doubling every 9 months and low-cost 1 TB (one terabyte of data) hard-disks should be available on the retail market before end of 2005. If one of these high capacity drives was used in a Digital Video Recorder (DVR) application, it would be possible to store more than 250 movies in DVD quality on these DVR.

Proxy servers are servers used by most of today's Internet Service Providers. These servers are used for security purposes (for example, as a firewall), for filtering, and for caching the same data regularly accessed by the customers of these service providers. Proxy servers can reduce the amount of bandwidth utilized on a network by providing cached copies of recently or frequently accessed files.

The number of broadband users around the globe has reached a total of more than 100 millions households, offering a new, universal, distribution path for video-based entertainment.

According to the Yankee Group, 20% of the US households will own a Personal Video Recorder (or Digital Video Recorders) by 2007. It is known in the industry that two-third of the owners of such recorders skip commercials on TV, dislocating the current advertising based model of television studios. The present invention can be used as a solution to this problem.

According to Parks Associates, the total cumulative market of network-capable consumer electronics devices will reach 285 million units by 2008. It is a huge number of devices that can use and benefit from the system and method disclosed in the present invention.

There currently are three systems existing today on the market to deliver multimedia on-demand services. These systems are satellite systems, cable systems, and movie-on-demand systems over the Internet.

Satellite systems, for example Echostar and Dish Network, deliver on-demand titles to an end-user through a satellite connection. There are many disadvantages associated with this method: the end-user must acquire expensive and cumbersome reception systems, there are significant barriers to entry for service providers (such as the launching of satellites for broadcasting and providing), the necessity of an external satellite dish with an unobstructed view of the sky in the direction of the satellite, and the system is mono-directional and prevents any mutual upload of the data to another party like with the current invention.

Cable systems, such as Time Warner Cable and Adelphia, have recently started to offer on-demand services to their customers. There are many disadvantages associated with these systems: the user must acquire expensive digital cable decoder, the selection of the tiles on the TV is complicated, the current analog cable infrastructure must be upgraded at high cost, the downstream bandwidth at peak time is easily saturated, and the operators do not have a way to attract customers from remote areas.

Movies on-demand systems over the Internet, such as Movielink and CinemaNow, deliver on-demand movies over the Internet. The problems associated with this method are the extremely high bandwidth required to stream these movies to a user, the total inconvenience of watching such movies with a PC, and that the user's PC must be turned on during a long time to download the data, etc.

Another method of providing multimedia content to a plurality of users is to send DVD or videotapes by postal mail. An example of companies using this method are Netflix Inc. and Walmart. Netflix in particular has been using a recommendation engine that recommends titles a user will probably like and are available for rental (not currently rented by another customer) from their inventory.

The problems associated with the postal mail method are that

these companies must maintain a huge inventory of DVDs;

the number of titles is limited; a lot of multimedia content like sporting events, concerts or documentaries are never released in DVD format; and

the delivery is done by postal mail, which creates a lot of “lost” DVDs in the mail, is a slow process and is an expensive delivery model (postal fees to send and return the movies). In addition, the postal mail method has the additional problems in that local distribution inventories must be created; there is impractical scalability: the cost of expanding distribution to new areas is significant; there is a low-level of security since most of the DVD protections (such as CSS) can easily be broken by utilities such as DeCSS; and the recommendation systems are basic: the suggested recommendations are limited to items available for rental at a particular time in a local inventory.

The present invention is less expensive, can use existing network infrastructures, does not significantly saturate the bandwidth of an upstream server and is extremely secure, while providing excellent selections tools and high resolution images to the user at the same time.

Other systems already exist to let customers inter-connect their Digital Video Recorder to others if they want to exchange recorded multimedia data (such as the SonicBlue Replay device) but there are two big disadvantages with such devices: there is no synchronization of the data thus preventing concurrent upload to other multiple devices (e.g. two users cannot simultaneously upload to another user a program that they have both recorded because they have not necessarily started recording at exactly the same time), and there is no control of the distribution of the files and therefore it presents an important copyright infringement risk already denounced by the Motion Picture Association of America (MPAA) and various movie and television studios.

The present invention provides users the possibility to create their own menu of selected multimedia content they can access every time they do not find something interesting to watch on the standard TV channels. Their reception unit is continuously updated with new content, each time they have finished to watch a fraction of the content previously stored.

There are several patents and patent applications for movie-on-demand and file-sharing systems. U.S. Pat. No. 5,966,440 (the '440 patent) discloses a method for transferring digital audio/video signals. The '440 patent discloses a “first party to second party” distribution system. The biggest disadvantage of the '440 patent is the cost associated to maintain the connection between the memory of the first party and the memory of the second party. If such a system would be used by an operator (first party) distributing digital content to a high number of customers (second party), the bandwidth of the connection of the first party would need to be extremely big and therefore very expensive. The advantage of current invention is that the digital content is distributed from memories coming from multiple, different, parties: no high-bandwidth connection must be maintained from the server of the first party since each participating party adds its own bandwidth that will be shared with other parties.

U.S. Pat. No. 5,899,582 (the '582 patent) discloses a method using a plurality of different storage disks to deliver movies-on-demand. The current invention discloses a superior method because the different segments of the digital titles are coming from a plurality of disk in a continuous and parallel way instead of a synchronous and serial manner. There is therefore no need to synchronize each disk transfer with the others (a very difficult task over today's electronic networks) and the reliability is much better since a problem with one disk would not cause the data transfer chain to stop.

A media-on-demand system is disclosed in U.S. Pat. No. 6,470,138 (the '138 patent). The current invention is an improvement of the method described in the '138 patent. Although both systems can be used for “remote” rental of multimedia titles, a physical information-stored medium has to be changed often in the system of this patent in order to provide a high number of titles to the consumer. This disadvantage does not exist with the current invention since its efficient transmission scheme enables the user to get the digital data delivered over the network (and not only the playback permission and/or public advertisements signals as in the '138 patent).

A near video-on-demand system is disclosed in U.S. Pat. No. 6,263,504 (the '504 patent). The ability of the current invention to store data continuously, with transfers occurring at any time and from multiple parties, allows the current invention to be superior to all the near Video on Demand systems (NvoD), such as the one disclosed in the '504 patent. The transfer of the data described is such said patents indeed uses the same “in advance” download method but these transfers are never flexible since they depend on time-shifted programs that are broadcasted. This causes a huge amount of transmitted data to be wasted such as in Pay-per-view systems.

Many VoD systems have been disclosed to solve the problems of data congestion of the movie server. Such a system is disclosed in European Patent Application 93870216.4 (the '216.4 application), which attempts to solve this problem by the addition of buffer servers managed by the on-demand system operators that are situated closer to the network access points of users. The present invention includes a data buffer embedded in the receiver system and is therefore placed below the network access point of the user. The present invention is a superior method as it enables a more rapid adoption of these systems by obviating the need for significant network hardware modifications. Optionally, a local buffer server managed by the access provider can be added to the present invention.

Peer-to-peer file sharing systems for PCs are known in the industry. Although variants exist, most of these systems are based on two network configurations: whether or not a central server is used.

An example of the first configuration that includes a central server is the “Napster” method. This method is described in details in PCT Applications WO 01/84799 and WO 02/15035, both filed by Napster. The “Napster” system is represented in FIG. 14:
1) Peer 1 (requesting file “XYZ” in this example) contacts the central index server to know where file “XYZ” can be found.
2) A list of the online peers that have the requested file “XYZ” available is returned from the central index server to Peer 1 (e.g. Peer 3 in this example). Also returned by the server is the information required to find Peer 3 on the Internet.
3) Peer 1 establishes a direct connection with Peer 3 and a data transfer is started between Peer 1 and Peer 3. The central server is not involved in the data transfer.
4) Additional connections with other peers that have “XYZ” available can be established to increase the transfer speed up to the maximum downstream speed of the receiving peer.
   An example of the second configuration that does not include a central server is the Gnuttella protocol or the Kazaa program that use a similar method. This implementation is represented in FIG. 15:
1) Peer 1 (requesting file “ABC” in this example) broadcasts an inquiry message to the closest peers to find one of them that has file “ABC” available. No central server is used so Peer 1 contacts multiple peers and each peer passes the message to another. These inquiry messages are only passed a determined number of times to avoid network congestion.
2) When a peer receives the inquiry message from Peer 1 AND has file “ABC” available, a response message is transmitted back so that a data transfer can be started with Peer 1.
3) If another peer, which has also file “ABC” available, receives the inquiry message later, an additional, separate, data transfer can be started with Peer 1 to increase the transfer speed up to the maximum downstream speed of the receiving peer.

While both configurations facilitate rapid distribution of media files over a distributed network, there is no effective system to regulating and ensuring the protection of copyrights. The current invention improves upon such file-sharing networks by ensuring the proper payment to copyright holders for use of the works distributed throughout the system. These file-sharing systems do not use any type of DRM (Digital Rights Management) method or other like copyright protection features. These systems further are software-based and intended only for PCs, whereas the present invention can be utilized across a broader range of devices, including but not limited to PCs, DVD players, televisions, set-top-boxes, wireless media adapters, internet media receivers, and portable multimedia players.

Additionally, no type of revision control is disclosed or used by these systems. Files in a Napster system can be renamed or modified, leading to inconsistent and varying file selection (e.g. different version of the files of a same song can be available). The current invention ensures a uniform filename and file content hierarchy, and cannot be modified by users. Another key advantage of the present invention is that a central server is controlling the integrity and revision of the files on the network, thus guaranteeing a high ratio between a title and the number of copies of this title available on the network for upload. The existence of too many variations of the copies of a title would dramatically reduce the performance of the system: the files would be recognized as “different” by the system and a lower number of systems would be available to participate for parallel downloads. Furthermore, the present invention does not rely upon the user to select the files made available for download to other users, as is disclosed in the Napster patent applications or with Kazaa. The current invention thus allows for the system to automatically provide more copies for distribution and avoid the participation of selfish users who desire to receive a maximum of files without sharing (or uploading) files for others.

Also known in the art is a new peer-to-peer engine called BitTorrent, an open source peer-to-peer distribution system (http://bitconjurer.org/BitTorrent). BitTorrent is a file distribution system that focuses on transferring a (large) single file in a very efficient manner by splitting the file transmitted over a peer-to-peer network in small-size packets so that each packet downloaded by a peer could be immediately uploaded to another peer downloading the same file. With BitTorrent, when multiple people are downloading the same file, they upload pieces to each other.

The method and system described in this application are superior to BitTorrent for several reasons:
Each BitTorrent peer has to download AND upload data (most often at the same time) to make the system work. The proxy method of the present invention enables a determined number of peers to upload data to a much larger number of receiving peers, which do not have to upload data at the same time, thus giving the possibility to the downloading peers to use their maximum downstream bandwidth. Forcing a peer to upload data would most of the time deteriorate its download speed and therefore slow down the system.
The efficiency of BitTorrent highly depends on the time peers stay online. Since BitTorrent is intended mainly for Internet PC users, the time these users spend online is highly unpredictable. The DDR units of the present invention remain connected by default to the network thus making transfer between the DDR units much more robust with no user intervention. In addition, the present invention enables transfer of a particular file to be scheduled at a particular time, thus enabling more peers to be connected at a particular time to potentially use an optimization method like BitTorrent. Thus, the present invention overcomes one of the weaknesses of the current version of BitTorrent: BitTorrent only works well when a substantially high number of peers are downloading the same file. The BitTorrent system is a lot less efficient when only a small number of peers are requesting the same file and/or if the transfers are spread over a long period of time, with peers disappearing from the network once the file has been downloaded on their machine and the drawback that the data transfers of BitTorrent are exclusively initiated by a user.
The “tracker” server of BitTorrent enables peers to find each other with almost no form of prioritization and/or selection, which results in a poor usage model. If a peer is busy downloading multiple files via BitTorrent, there is no method for balancing the load between the upload/download of these different transfers. With the DDR unit system of the present invention, an upload is for example only forced when necessary and a priority can be given to a particular file (e.g. prioritization of the file that is the rarest on the DDR network).
Finally, the major limitation of BitTorrent is that it is an optimization system for downloads “in-progress”. Once a file has been downloaded, the majority of the peers will close the BitTorrent window and they can no longer be used as a potential data source. There is no history tracking to enable these peers to become a source of data for future transfers of the same file. Optimization only occurs between peers transferring a particular file at the same time.
   Known in the art are other peer-to-peer systems that can be categorized in one of the categories above and suffer from the same limitations: Ares, Blubster, Filespree, Filetopia, DirectConnect, eDonkey, OpenNap, Overnet, Piolet, WinMX, Freenet, Entropy, WASTE, FastTrack, BT++, Burst!, Shareazaa, TorrentStorms, Exosee, GLTPoliane, Xolox, SoulSeek, Nova, iMesh, Limewire, Phex, AudioGnome, PeerGuardian, Peeranha, DICE, BadBlue, The Circle, The Bridge, Inoize, Konspire, Drumbeat, Chord, Softmax and ToadNode.

In addition, the peer-to-peer systems described above and elsewhere in the art:
None of these peer-to-peer systems use or disclose any kind of scheduling. Once a file is selected, the data transfer starts as soon as at least one source peer with the requested file becomes available. Once a file is found available on a peer for transfer, the system never delays the transmission of the data. Such a delay could dramatically improve the performance and operation of the peer-to-peer network, in particular if the peer-to-peer data transfers are very frequent such as with an “Internet Television” model.
These peer-to-peer systems do not distribute the transfer of data over time: if a user has selected different files for a total of 20 gigabytes, these systems will keep transferring data until the entire 20 gigabyte have been fully downloaded. At the current speed of a cable modem, it represents several days of non-stop transfer for a single user, which is an unacceptable model for the network service provider (e.g. Internet Service Provider).
None of these peer-to-peer systems use or disclose a systematic use of proxy servers to optimize the transfer of data to multiple peers. The use of a proxy in the above-mentioned peer-to-peer systems is only an option that a user can select for one of the following reasons:
   a) Enable a quicker new download if a transfer has been previously interrupted
   b) Enable anonymous transfers
   c) Solve different connections problems due to firewalls, proxy or Network Address Translation (NAT) servers.
None of these systems synchronize the data transfers between peers that are members of a same network (e.g. same Internet Service Provider) and are receiving (or have requested) a same file. This results in an excessive, unnecessary, load on the backbone connection of these providers. It makes these peer-to-peer systems not welcome by these providers and many have started using filtering techniques such as those developed by CISCO to reduce the bandwidth allocated to such peer-to-peer protocols on their network.
None of these systems give the possibility to a user to prioritize the items the user desires to receive. The system and method described in the present application enable a user to establish a clear priority order; this order depends on a user's wishes and/or the nature of the multimedia file (priorities for daily shows must for example be set so that they're transmitted at least once every 24 hours). This application discloses a superior system and method to prioritize titles common to a plurality of users.
None of these systems enable a user to make a search or select a file if the file is not available on at least one peer that is online.
For a single file transfer, the systems described above exclusively use a “Many-to-one” or “One-to-one” connection scheme between the peers.

The program PeerCache, from company JOLTID (http://www.joltid.com/), is a peer-to-peer application that has tried to use proxy servers to reduce the bandwidth consumed by the P2P users of an Internet Service Provider. The PeerCache application is used as a cache server between P2P programs (such as Kazaa) and the peers outside of the network of the ISP. It creates a transparent layer that redirects file queries to a local cache when possible. This programs helps to reduce the volume of the P2P traffic that goes outside of the ISP network since a local cache is used when the file is available in the cache.

The biggest limitation of PeerCache (which the present invention overcomes) is that there is no mechanism to systematically make the peers that have selected the same content download the data using the proxy (by performing the transfers around the same time for example). With PeerCache, the transfers of identical data are not grouped together and are not triggered by a mechanism connected to the receiving peers. A very big cache memory is also required with PeerCache, a problem that would only get worst when used for the transfer of large files. With PeerCache, not enough items “remain” cached in the cache memory to make the system really work.

The combination of three aspects of the present invention (a scheduling system, an analysis of multiple lists of selected items, and the use of proxy servers) make the present invention superior to PeerCache and more efficient.

The limitations of these peer-to-peer systems therefore create a very inefficient, complex, network of interconnected peers as represented in FIG. 16a. Although these limitations have not been so far a major problem in the industry (mainly because these systems were used to transfer relatively small files like MP3s) they would create numerous problems if the models described above were converted in file distribution systems for large multimedia files.

Also know in the art is the capability to implement peer-to-peer systems in embedded consumer electronics appliances such as PDAs, mobile phones, etc. A good example of this technology is the JXTA protocol (http://www.jxta.org) introduced by Sun Microsystems Inc. in March 2001 that enables peer-to-peer implementations in consumer electronics devices that support for example Java Micro-Edition in their operating systems. Other examples include other peer-to-peer protocols for consumer electronics devices like Bluetooth (http://www.bluetooth.org), USB on-the-Go (OTG), Jini (http://wwwjini.org) or even Jnutella (http://www.jnutella.org/, disclosing a P2P system for mobile phones).

An example of a P2P network of consumer electronics devices is disclosed in Patent Application 2003/0118014 (the '014 application) titled “Method and system for customized TV viewing using a peer-to-peer network”. The '014 application discloses a P2P network formed by interconnected Personal Video Recorders. The '014 application suffers from several disadvantages such as the necessity of supporting recording (which makes the system expensive). The peer-to-peer function is also extremely basic, which makes the system of patent application '014 impossible to use for systematic delivery of multimedia data.

Also known in the industry are some Internet video-on-demand vendors using peer-to-peer technologies to deliver movies to their end-customers. An example of one of such vendors is the website Transmissionfilms.com using products from JIBE Inc. The products and services provided by TransmissionFilms and JIBE are inferior to the present invention since they do no include the step of creating a queue for each user and therefore cannot benefit from the technical advantages of doing so: (1) no proxy method is possible, (2) no selection of the best transfer parameters based on an analysis of a plurality of queues, (3) the transfers cannot be scheduled, (4) no possible selection of a particular item from the queue that can be transmitted very quickly, etc. The JIBE and TransmissionFilms systems are limited to personal computer platforms and will significantly suffer from saturation problems.

Also known in the industry are some peer-to-peer streaming technologies mainly developed for Internet radio or streaming video applications from companies such as Blue Falcon, Kontiki, Chaincast, Centerspan, or Allcast. These applications focus on the concept of “bandwidth-sharing” offered by peer-to-peer. The goal of these systems is to enable a higher number of nodes to participate to a streaming transfer and/or decrease the cost of the bandwidth required to stream data, a very common task for Internet radio stations for example. An example of such a system is disclosed in U.S. Pat. No. 5,884,031 (the '031 patent). These applications are similar in some aspects to the present invention in that the concept of determining the best route and the optimal “match” between sending and receiving peers. These applications have several limitations that the present invention overcomes:
These applications lack the benefits enabled by scheduling the transfers over time;
These applications lack the benefits given by combining peer-to-peer transfers with an analysis of a plurality of queues of items selected by the end-users. The “real-time” nature of these peer-to-peer streaming applications prevents such a method.
Streaming is an unreliable technology. In the case of multimedia data, the very last thing the users want to happen when watching a movie is buffer and “glitches” problems. The method described in the present invention overcome these problems.
The users of such applications can go off- and on-line in a very sporadic manner which results in many complications for the network operator.

The present invention overcomes all of the above-detailed deficiencies of the present art.

### SUMMARY

The current invention comprises a digital Data Download Reception unit (DDR unit) used to download data files over an electronic network (or equivalent) and the method for using the DDR unit system for delivering on-demand or near on-demand multimedia services.

The upstream port of the DDR unit is connected to a network and a downstream port can be optionally connected to a PC or another consumer electronic device (e.g. portable video player). The DDR unit contains a mechanism used to establish the connection with the network, receive and decode data, and store them on an internal mass-storage support.

Once downloaded on the reception unit, the data can be transferred to a PC or transferred to another consumer electronic device. Another alternative, when the data are multimedia data, is to connect the reception unit directly or indirectly to a restitution device (e.g. TV monitor, stereo system) in order to watch/listen to multimedia data with the built-in playback mechanism.

The device contains a network interface engine able to establish communication with other DDR units in a device-to-device configuration over the network.

The control and configuration signals are communicated between each DDR unit and a central server. The transfer of the data signals occurs between multiple DDR units.

The DDR unit can be used in three modes: a download mode, a data retrieval mode and a playback mode. The DDR unit is optionally continually switched on and can optionally be configured to be by default in download mode.

Data Download Mode

In download mode, the DDR unit establishes the connection with the network and is recognized by the other DDR units as a new valid node. The DDR unit receives the latest list of multimedia files requested by a user and knows the appropriate other DDR units in the network that have the desired data. Although a transfer can be started immediately, a delay before the download is preferably used to enable an optimization method disclosed in section III.C.

During the transfer, other nodes asking for data already stored on the reception unit of a user can interrupt the DDR unit.

Since the multimedia files are spread across a large number of distinct DDR units—owned by different people—, the transfer occurs continuously between multiple different parties.

The data stored in the DDR unit are encrypted and a dispatch server authorizes the different transfers within the DDR unit network through a proprietary algorithm.

Data Playback Mode

In data playback mode, once multimedia data have been downloaded, the DDR unit is connected to the restitution device and offers a selection menu to the user through the video output or similar. The user then selects in a menu which multimedia file the user wants to play via an IR transmitter or other selection device.

The menu can give a report to the user about the user's account history (such as billings and the current queue) and the status and performance of the user's DDR unit.

In playback mode, the DDR unit can respond to all the typical commands of a multimedia system: rewind, fast forward, pause, scene selection, etc.

Data Retrieval Mode

In data retrieval mode, the DDR unit is connected to another device such as a downstream Ethernet port or a universal serial bus (USB) port. A program on the second device connects the two apparatus, authorizes the communication and transfers the data at a much higher rate than if the data were downloaded directly from the network described in the previous section. In this mode, the DDR unit acts here as a buffering or “Download Assistant” unit

### BRIEF DESCRIPTION OF THE DRAWINGS

These and other features, aspects, and advantages of the present invention will become better understood with regard to the following description, appended claims, and accompanying drawings where:

FIG. 1 shows one embodiment of the data download reception system.

FIG. 2 shows one embodiment of the data download reception unit.

FIG. 3 shows one embodiment of one of the modes of operation.

FIG. 4 shows one embodiment of the system used in a case where the upstream port of the network is close to the multimedia restitution device (such as a television).

FIG. 5 shows one embodiment of the system used in a case where the upstream port of the network is not close to the multimedia restitution device (such as a television).

FIG. 6 shows one embodiment of the internal architecture of a data download reception unit.

FIG. 7 shows one embodiment of an algorithm used by a dispatch server for optimizing, selecting, and scheduling the peer-to-peer data transfers.

FIG. 8 shows one embodiment of the content of the mass-storage component of the reception system.

FIG. 9 shows one embodiment of the remote control for the reception system.

FIG. 10 shows one example of a standard data transfer within the network formed by the reception systems.

FIG. 11 shows one example of a data transfer with proxy optimization within the network formed by the reception systems.

FIG. 12 shows different embodiments of the present invention in different consumer electronics applications.

FIG. 13 shows a chart of the relative volume of data transferred during one day on the network of a broadband provider.

FIG. 14 shows an example of a peer-to-peer system that utilizes a central server such as “Napster” systems.

FIG. 15 shows an example of a peer-to-peer system that does not need a central server to operate such as “Gnutella” systems.

FIG. 16a shows the multitude of “many-to-one” or “one-to-one” connections that occur in a network of connected peer-to-peer network.

FIG. 16b shows the asymmetry between the download and upload transfer speed on the access of a broadband network such as a cable modem.

FIG. 17 shows one embodiment of the present invention's peer-to-peer system using the proxy optimization method.

FIG. 18 shows a flowchart of one embodiment of a data transfer with proxy optimization

FIGS. 19a and 19b shows a flowchart of the main processes of one embodiment of the present invention.

FIG. 19c shows a flowchart of one embodiment of the present invention's selection tool process.

FIG. 19d shows a flowchart of the main processes of one embodiment of the data download reception unit of the present invention.

FIG. 19e shows a flowchart of the turn on process of one embodiment of the data download reception unit of the present invention.

FIG. 19f shows a flowchart of new content retrieval process of one embodiment of the present invention.

FIG. 20a shows an example of a monitoring table showing the access time or probable performance of transfers between a plurality of DDR units and a plurality of proxy servers used in one embodiment of the present invention.

FIG. 20b shows an example of the input and output data of a recommendation engine used in one embodiment of the present invention.

FIG. 21 shows different embodiments of the present invention in different consumer electronics applications.

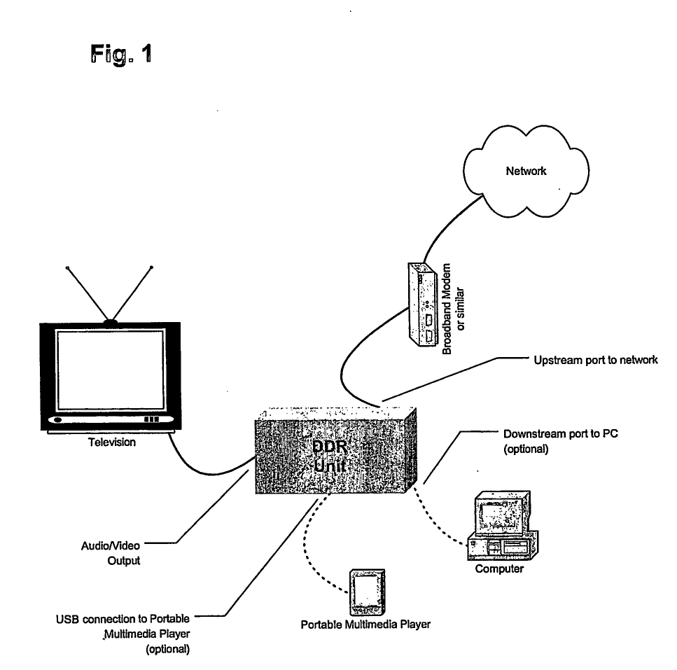

It is understood that the connections over electronic networks as described herein and in the Figures are representative, and do not necessarily depict direct connections between the elements of the system. Intermediary routers or relay stations can be utilized to establish these connections.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for teaching one skilled in the art to employ the present invention in virtually any appropriately detained system, structure, or manner.

Definitions

Unless defined otherwise, all technical and scientific terms used herein have the same meaning as commonly understood by one of ordinary skill in the art to which this invention belongs. Generally, the nomenclature used herein described below are well known and commonly employed in the art. Conventional methods are used for these procedures, such as those provided in the art and various general references. Terms of orientation such as “up” and “down” or “upper” or “lower” and the like refer to orientation of parts during use of a device. Where a term is provided in the singular, the inventor also contemplates the plural of that term. Where there are discrepancies in terms and definitions used in references that are incorporated by reference, the terms used in this application shall have the definitions given herein. As employed throughout the disclosure, the following terms, unless otherwise indicated, shall be understood to have the following meanings:

“Download” means the act or instance of transferring data or information over a network from a remote memory (source) to the local memory of another device (destination). This can be for a large file over a computer network, and can be utilized as a verb (referring to the action of downloading) or a noun (a download).

“Upload” means the act or instance of transferring data or information over a network from a local memory of a device (source) to a remote memory (destination). This can be a large file over a computer network, and can be utilized as a verb (referring to the action of uploading) or a noun (an upload).

“Downstream” means in the direction away from the source of a data stream.

“Upstream” means in the direction opposite of a data stream.

“Multimedia” means the combination of moving and still pictures, sound, music, and words, especially in entertainment including for example movies, television programs, on-line classes, sporting events, songs, audio books, concerts, documentaries, home shopping programs, or equivalent.

“Audio” means the transmission, reception, or reproduction of sound, also a sound signal. “Audio” can further be of or relating to sound or its reproduction, especially high-fidelity reproduction.

“Video” means the transmission, reception, or reproduction of moving images and sound, such as movies and television. “Video” also refers to the visual portion of television.

“On-demand” means upon request. “On-demand” can further refer to when requested or needed in real-time.

“Multimedia-on-demand (MoD or MOD)” means multimedia services or data delivered or transferred in real-time upon request.

“Video-on-demand (VoD or VOD)” means video signals delivered or transferred in real-time upon request.

“Near-video-on-demand (NvoD or NVOD)” means video signals delivered or transferred in real-time upon request with the delivery only starting after a short delay after request.

“Codec” means coder/decoder. “Codec” refers to an electronic component encoding and decoding digital data into audio or video signals and vice versa. “Codec” is also known as “digital signal processor.”

“Digital rights management (DRM)” means a set of technologies content owners can use to protect their copyrights. In most instances, a system that encrypts digital media content and limits access to only those users who have acquired a proper license to utilize the content. DRM is a the technology that enables the secure distribution, promotion, and sale of digital media content over the Internet.

“File-sharing” means sharing and distributing files to other users over an electronic network.

“Playback” means the act or instance of reproducing sound or pictures previously recorded.

“Retrieval” means an act or process of getting, bringing back, or recovering data (as information) from memory.

“Output interface” means an electronic or electromechanical connection between an electronic device and other devices that can be used to transfer data out of the device in the form of text, images, audio, video, any other multimedia format, or any other form of electrical or wireless signals.

“Chipset” means a collection of integrated circuits or a set of electrical functions of an integrated circuit that are designed to be used together for some specific purpose.

“Server” means a computing program which provides some service to other client programs or computing devices. The connection between client and server is by means of message passing, over a network, and utilizes a protocol to encode the client's requests and the server's responses. A server can additionally refer to a computing device which provides some service for other computing devices connected to it via a network. The term server can refer to both computing programs and computing devices. The functions of a server can be performed by either a single server or multiple distributed servers. A single computing device server can perform multiple computing program server functions. In particular, a device such as a DDR unit can perform one or more, or all, of the functions of one or more of the servers mentioned in this application.

“Multimedia server” means a server performing a plurality of operations on multimedia data. The operations include encoding multimedia data into different formats compatible with the DDR units, encrypting files for protection against sniffing, tampering or altering, and encapsulating Digital Rights Management components into the file.

“Mass-storage server” means a large capacity server storing data readily accessible to other devices, the server being protected from unauthorized access.

“Billing server” means a server in charge of presenting statements of costs to a user and processing the payment thru an electronic transaction.

“Electronic content server”, “electronic content catalog server”, or “catalog server” means an electronic catalog or electronic programming guide of multimedia items made available to a user; the server displaying details about each available item and displaying information about the items previously selected by the user. The electronic content server is able to display status and control information to the user and it enables the user to make the selection of items. A website could for example operate as an electronic content server.

“Chunks” means a group of data, usually of a pre-set size, that can be assembled with other chunks to form a bigger file.

“Mass-storage unit” means an electrical device able to store data in digital format. A mass-storage unit can for example designate one or a combination of a plurality of the following items: a hard-disk drive, hard drive array (RAID), a CD-ROM, a CD-RW, a DVD drive, a flash memory, a RAM-type memory; whether these items are read-only and/or read-write.

“Proxy server” means a server providing a cache of items available on other servers presumably slower or more expensive to access. A proxy server is most often used to connect multiple machines on a local area network to a public network such as the Internet, the proxy servers reduce the amount of bandwidth utilized on a network by providing cached copies of recently or frequently accessed files. The cache has usually an expiry algorithm, which flushes data according to their age, size, and access history.

“Multicasting” means a method for transmitting data across an electronic network from a single sender to multiple receivers. The data are usually grouped in packets with a special destination address which corresponds to a plurality of client nodes.

“Broadcasting” is a type of multicasting when data are sent to all the nodes of the electronic network.

“Watermark” means a hidden mark or other identifying information embedded in data, most often as an invisible pattern of bits, allowing for the tracking of illegal use or unauthorized distribution of data usually copyrighted.

“Sink” or “data sink” means a device that receives information, control, or other signals from a source.

“Node” means an addressable device connected to a network. In particular, a data download reception unit, a user, or a server can be referred as a node of a network. “Peer” is an equivalent name for “Node”.

“Coordinating transfers of data” means organizing, regulating and combining electronic transmissions of data in a common action or effort including establishing conditions and times at which said transmissions of data are planned to start, occur, or end.

“Monitoring” data means watching, checking, or keeping track of data systematically with a view to collecting information. This can include surveillance and control of the data, comparison between data, collection and analysis of data over a period of time, which permits input of the results into the steering and control of processes and activities.

“Many-to-many” means a relationship between two entity sets in an entity-relationship model, in which many entities of one entity set are related to many entities in the other. In the particular case of peer-to-peer, “many-to-many” refers to an entity-relationship model wherein many entities (a plurality of peers) of one entity set (the sending peers) transfer one or more segment(s) of data to many entities (a plurality of peers) of one other entity set (the receiving peers). Each one or more segment(s) of data being downloaded by a plurality of receiving peers without being re-sent multiple times by a sending peer(s).

### Overview

The DDR system includes a portable DDR unit and two base stations. These base stations provide power to the DDR unit and they enable its true portability by providing the appropriate connectors in such a way that the DDR unit can be plugged easily in the base stations without reconnecting wires each time it is transported from one base to another.

The primary base station includes power supply connectors, the upstream and downstream ports to the network, and the audio and video connectors.

The secondary base station consists of the same architecture without the audio and video connectors. Multiple base stations can additionally be used to utilize the DDR system in different rooms of a residence.

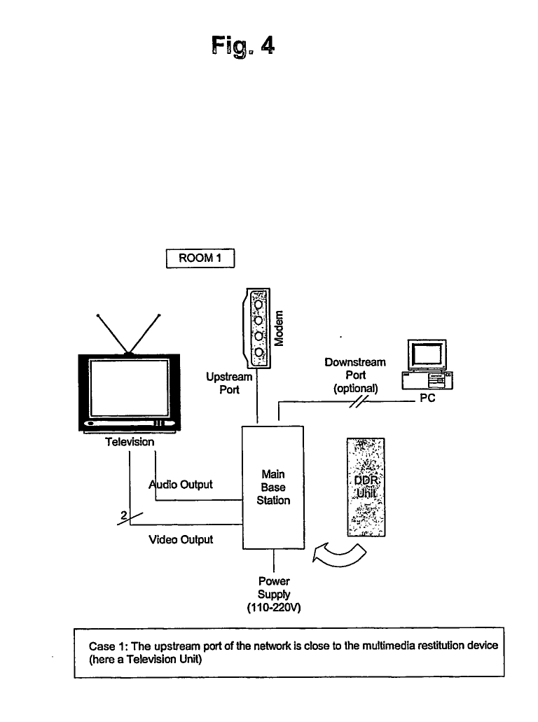

There are 2 possible configurations for the system. In the first example, the upstream port to the network is close to the multimedia restitution device (e.g. cable modem sitting near a TV). In this example, the DDR unit is only plugged in the primary base station as showed in FIG. 4. The base station sits next to the TV as well as next to the upstream link to the network. The DDR unit is essentially used in download and playback mode.

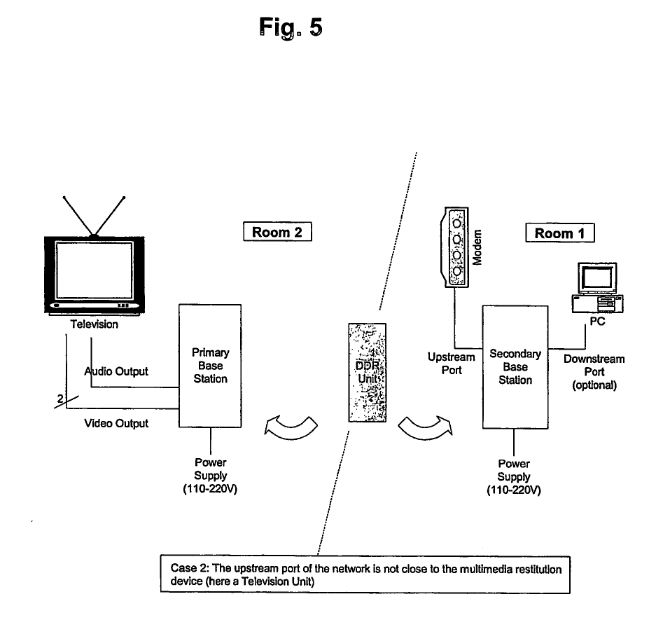

In a second example, the upstream port of the network is not close to the multimedia restitution device (e.g. cable modem sitting next to a computer with the TV in a different room). In this example, which is provided in FIG. 5, two base stations are required. The primary base station is close to the multimedia restitution device and provides the audio and video connection. When plugged in this primary base station, the DDR unit is used in playback mode. The secondary base station is placed next to the cable modem/PC. When plugged in this secondary base station, the DDR unit is essentially used in download mode and never in playback mode. This second example illustrates the true portability of the DDR units that can then be easily ported from one base station to another.

The DDR unit can be used in retrieval mode in both cases.

I. Hardware Description

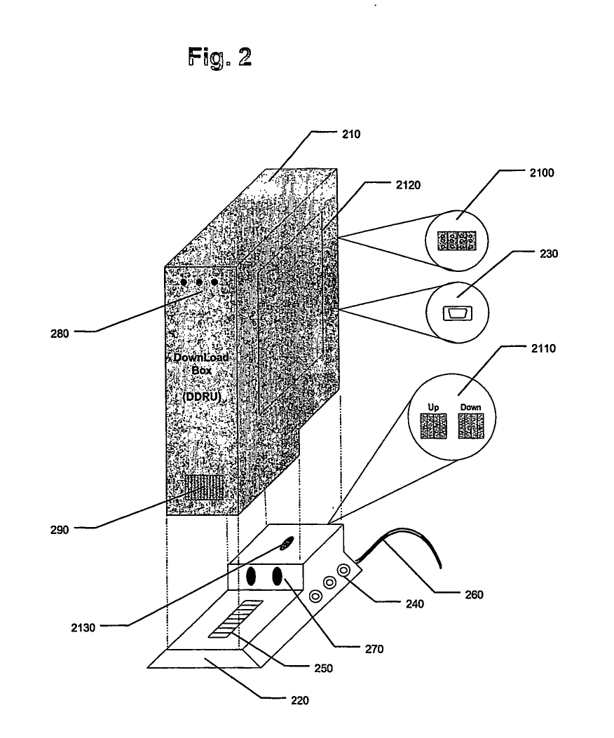

In one possible embodiment, the DDR unit is constituted by a rectangular box (210) as showed in FIG. 2. On the front panel, the DDR unit includes color LEDs (280) and an infra-red command receiver (290). A USB port (230) and jumper switches (2100) are available on the back.

The DDR unit can be plugged on a base station (220) and is powered by power connectors (270) with data transmitted between the DDR unit and a base station through data connectors (250).

Network ports (2110) are available at the back of the base station as well as a power cord (260). The Audio and Video connectors (240) are available on the right side of the base station (or on the back side in some models).

There is one lid (2120) on one side of the box that enables the user to open the box and remove the internal mass-storage unit in case the user wants to upgrade the user's system to a version with a bigger internal storage memory.

A. Internal Architecture

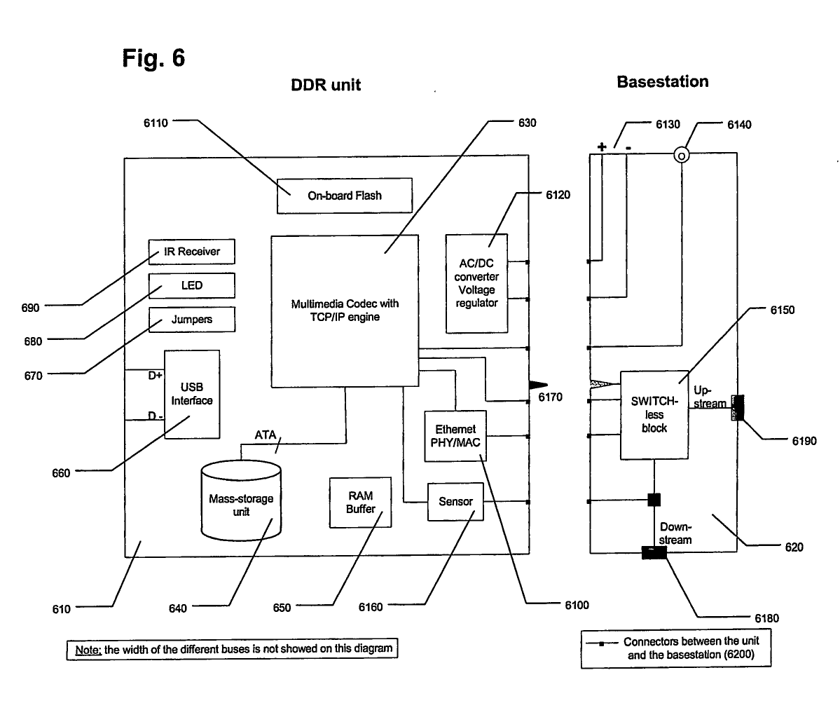

FIG. 6 shows the internal architecture of a DDR unit. A DDR unit is showed on the left (610) and a base station on the right (620). At the core of the system is a multimedia coder/decoder (630) that performs the 4 main functions of the system: connection to the network, data download, data storage and retrieval, and multimedia playback. An example of a codec is the BSP-15™ from Equator Technologies, Inc. A flash memory (6110) is included in the system so the firmware can be updated remotely.

Power is supplied to the system through an AC/DC converter with an integrated voltage regulator (6120). This piece provides power to all the components of the DDR unit.

Data are received from the network through an Ethernet PHY/MAC (6100), they can be buffered in RAM memory (650) if necessary, before being finally stored on an internal mass-storage mechanism (640).

General purposes I/Os are also available:
To send user commands to the codec through an infrared receiver (690)
To indicates the status of the DDR unit via different color LEDs (680)
To receive configuration information through jumpers (670) set by the owner of the DDR unit.

A universal serial bus (USB) interface (660) is also available to configure the DDR unit and the interface can be used as a debugging or data port. A sensor (6160), a hardware pin (6170) and a SWITCH-less block (6150) are required to operate the DDR unit if a switch-less mode is desired.

The signals of the DDR unit (610) are connected to the base station (620) by a multitude of connectors (6200) as showed on the diagram. The external connectors of the base station are power connectors (6130), analog audio/video connectors (6140), the upstream network port (6190) and the downstream network port (6180).

The analog audio and video output signals (6140) are protected by a copy-protection mechanism similar to protection provided by products of the Macrovision Corporation. This protection can be embedded in the codec (630) or established through an external component (unillustrated).

The codec (630) contains also the internal (private) security keys used to identify the DDR unit and decode the commands received from the network.

B. Remote Control

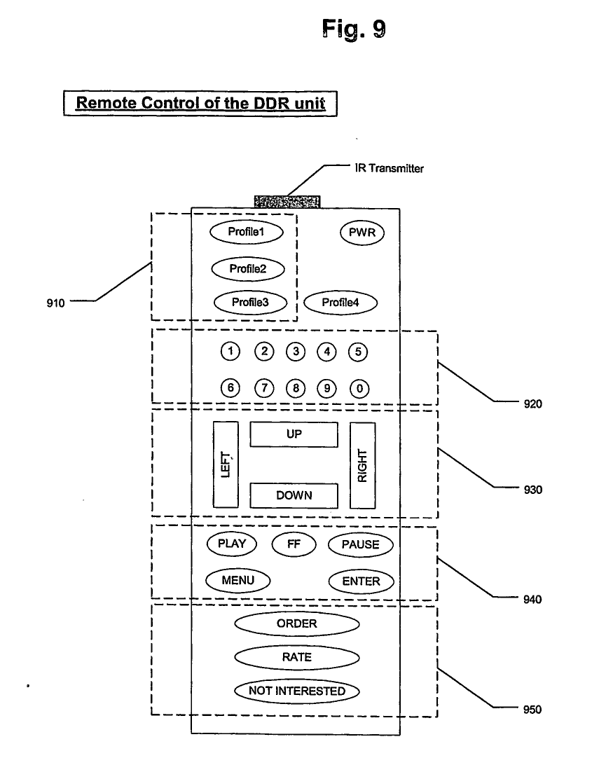

A remote control, one possible embodiment as described in FIG. 9, is also shipped with the DDR unit and the base stations. The remote control includes different command signals:
a) Traditional command signals of a multimedia remote control (940) like PLAY, PAUSE, STOP, FAST FORWARD, MENU, ENTER, etc.
b) Specific signals for user/profile management (refer to section III.G) e.g. PROFILE1 (910), PROFILE 2 (910), PROFILE3 (910) . . .
c) Direction keys (930) (UP, DOWN, LEFT, RIGHT)
d) A standard numeric key pad (920)
e) Specific signals for the selection and rating of the titles (950) e.g. ORDER, RATE, etc.
   Signals b) and e) are specific to the DDR unit system.
   II. Method and Mode of Operation

The present invention includes the method of using a DDR system for the electronic distribution of digital multimedia files.

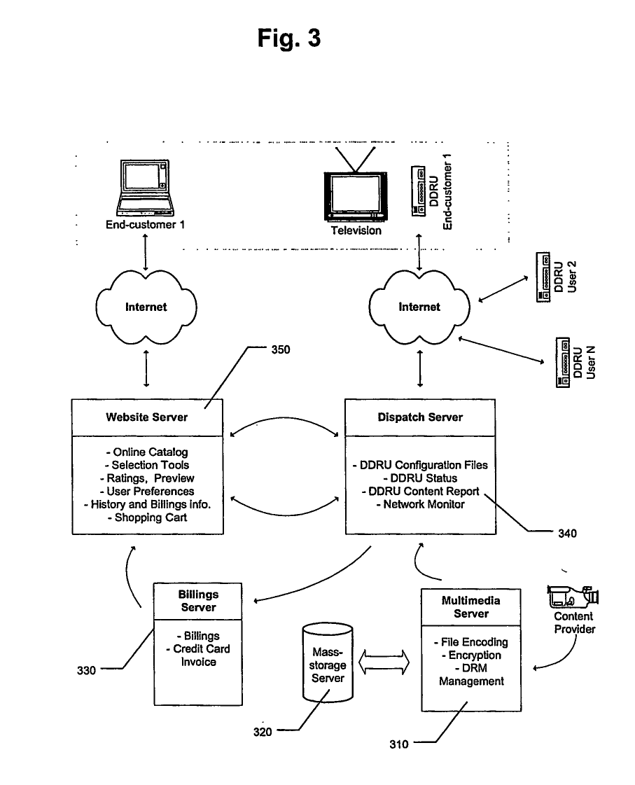

An overview of one embodiment of the present invention comprises the operations below and is demonstrated in FIG. 3.

A. Selection of Multimedia Titles on Server

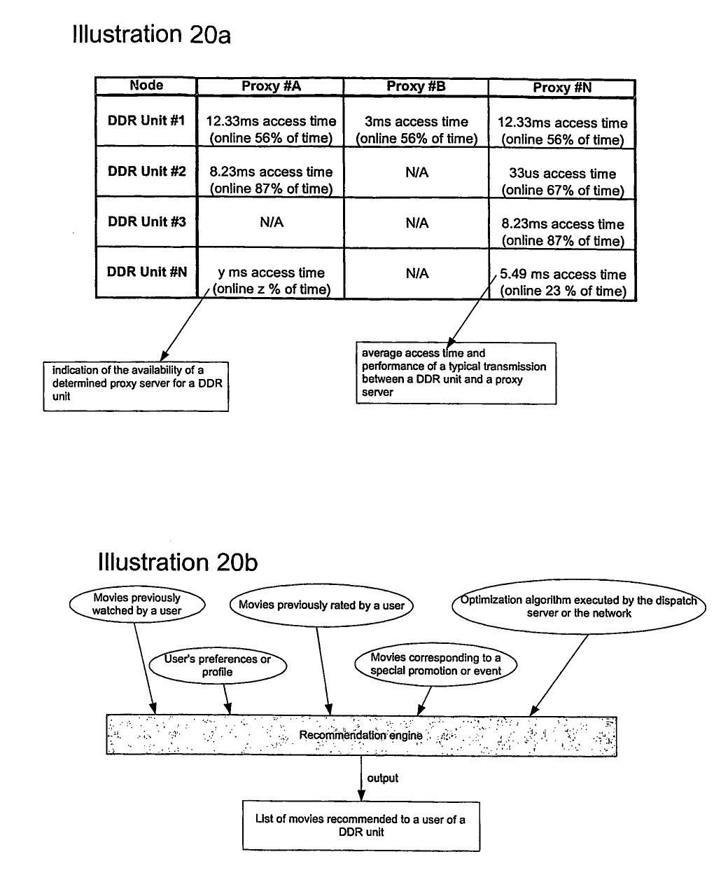

A user logs in on a catalog server (350) of a provider and browses a large library containing a plurality of titles available for selection. The server (350) can comprise a plurality of servers, such as a web server, a cable system server, an audio-on-demand server, a satellite video server, or any other like server. The titles on the server (350) include (but are not limited to) movies, TV show re-run, documentaries, home shopping programs, on-line classes or sporting events. Different tools are available to help the user to make the user's selection: movie trailers, “best of” ranking, overview, free preview, search engine enabling the search on one or more of the features of the multimedia titles, feedback and ratings from other users, etc. A recommendation engine is also available and recommends titles to the user. One possible embodiment of such a recommendation engine is illustrated in FIG. 20B. Recommendations are generated electronically based on the preferences a user has previously defined, or on similar content a user has selected in the past, or on items a user has positively rated in the past, or on items corresponding to either a special promotion, a special pricing or a special event (e.g. Christmas, Valentine's Day, World Cup Soccer, election coverage, etc.). Items determined to be transmittable relatively fast or relatively efficiently as determined by an optimization algorithm running on the dispatch server are also automatically recommended and combined with the recommendations above.

Each time a title is selected, the title is added to the user's wishlist (or “user's queue”). The user is able to remove titles from this list and redefine the priorities in the list at all times if desired. Said priorities defined the preferred order in which the title may be delivered to the user. Additional titles can be added to the user's wishlist at the user's convenience. The wishlist therefore includes a multitude of titles corresponding to items desired to be received as soon as possible (e.g. existing movies) or at a later date (e.g. future episodes of a TV shows or future football games). These titles can be individually selectable (e.g. “The Matrix Reloaded”) or globally selectable (e.g. “Friends Season 4”).

The user is able to choose the title, language and quality (sound and picture) of the multimedia file as well as what the user wants to do with the file (playback restricted to the DDR unit, copy authorized to a portable player, copy authorized to a PC, how many times, timeframe, etc.). This allows different business models to be used such as rentals based on play counts or expiration dates. The business rules are different for each user and are communicated to each DDR unit in a separate license file.

The system also verifies the user has the right to gain access to the chosen file based on different criteria like location (territoriality right), age ratings or subscription plan. The user is also able to protect the title chosen by a password. This password must be entered on the remote control before the title can be played back or transferred to another PC or consumer electronic device.

This method is also applicable to offline tools that enable the user to browse a catalog of titles when the user is not connected to the Internet (for example, catalog, mail-in order, postcard, pre-paid flyer, phone order, brochure, etc.). The library of titles can possibly be accessed from the TV as well (or any other consumer electronics device). In another embodiment, advertising banners commonly available on the Internet can also be used for the selection of the data. A user can selected a title and add the title to the user's wishlist by clicking on the banner.

Data comprising user identity, the list and priorities of the selected items, the format chosen and the DRM options are then transmitted to a dispatch server (340) that receives these data from every user of a DDR unit.

B. Dispatch Server

The dispatch server (340) then communicates data to the DDR unit describing which file has to be downloaded. The data may further comprise information about when the transfer should start (time of the day or special trigger signals), how the transfer will occur (which method), and which other DDR units are available to participate in the transfers to send or receive data, which data or segment of data will be transferred, and which title in the user's queue will be transferred. The benefits of transmitting such data from the dispatch server can be illustrated in the table below:

| Parameter | Benefit |
|---|---|
| Data indicating WHICH file | Enables an operator to give instructions to a DDR |
| has to be downloaded | appliance to prioritize the transfer of a particular file |
| | from its storage unit. |
| Data indicating WHEN the | Enables an operator to schedule transfer(s) at a particular |
| transfer should take place | time, for example during non-peak time on the network. |
| | Enables transfers of identical data to be grouped |
| | together, which significantly increases the efficiency of |
| | the transfers. |
| | Enables transfers to be scheduled at a time a higher |
| | number of peers are available to participate to the data |
| | transfers and receive the file they all have requested. |
| Data indicating HOW the | Enables the system to select the most appropriate method |
| transfer should occur | of transfer for different given situations. |
| Data indicating WHICH DDR | Enables “network friendly” P2P data transfers occurring |
| units send (sources) and/or | inside the network of an Internet Service Provider with |
| receive the multimedia data | minimum use of the backbone bandwidth. |
| (targets) | Increases the integrity and security of the network; the |
| | peers allowed to transfer data are chosen and authorized |
| | by the dispatch server. |
| | Higher efficiency: the DDR units that send/receive data |
| | are selected by the network in order to maximize the total |
| | amount of data transferred (and not only to maximize the |
| | speed of independent transfers). |
| | The peers participating in a transfer can be pre-selected |
| | based on the history of performance of previous |
| | transfers and/or locations. |
| Data indicating WHICH | Guarantees the best distribution of seed data on the |
| “chunk” of the data has to be | network. |
| transmitted | Ensures there are enough copies of a particular segment |
| | of data in the network. |
| Data indicating WHICH title | Enables different prioritization models to be used |
| from the queue is transferred or | depending on the content to be transferred. |
| transferred next | Enables the network to send another title from a user's |
| | wishlist as soon as the user's DDR unit is capable of |
| | accepting more data. |
| | Enables the network to send a particular title from the |
| | queue if said item can be transmitted particularly |
| | efficiently/quickly. |

Enabling a highest number of peers to participate in a peer-to-peer data transfer is an important aspect of this invention that dramatically improves the existing art. The creation of a wishlist for each user, the promotion of a particular title during a substantial period of time before said title is available for transfer, or scheduling/grouping the data transfers of identical data together are a few examples of how this can be implemented.

The title to be downloaded can be the first choice in the list of the user or one of the titles chosen, but not necessarily the first one. The dispatch server can indeed choose to delay the download or download only a specific title, in a lower position in the user's wishlist, so that an optimization method can be used as disclosed in section III. C.

The server can also optionally provide additional information to help the DDR unit to locate the files on the network formed by the other connected DDR units, and/or maximize the bandwidth distribution. This is optional since the internal engine of the DDR units have been designed to have the capability to find the appropriate files on the network by sending inquiry messages to the other DDR units, independently of the dispatch server.

C. File Download

The download protocol is able to manage data sent simultaneously to or from different DDR units and can re-start a download where it was stopped if a transfer is interrupted. This can be done in both the uplink and downlink directions. The data transfers are performed in accordance to encrypted instructions previously received and validated by the DDR unit from the dispatch server.

It must be noted that the end-user is preferably not allowed to select files or groups of files on the network. The user's selection is restricted to select titles in a central library as described in section A: they do not directly select files on other DDR units nor does the user choose from which DDR units they want to receive the content.

Data are downloaded to the DDR unit until the space of these stored data reaches a predetermined limit. New data (corresponding to another item from the wishlist of a user) will be transmitted next when space is made available. As soon as data are stored on a DDR unit, a particular segment of these data may immediately be transmitted to another DDR unit. At the same time, the network manages to continuously maintain a determined number of downloaded titles on a DDR unit in order to always offer to its user(s) something ready to be watched.

The download of the data can occur at a substantially distinct moment than the selection of the titles described in section II.A.

D. Playback Authorization and Invoice

When the download of a file on the DDR unit is completed, the DDR unit sends a signal to the dispatch server. The server verifies the integrity of the received file on the unit, notifies the user of the reception and invoices the user through a billing server (330). At the same time, the DDR unit sends a request to a license clearing (or digital rights management) server (illustrated) that authorizes the playback for the multimedia file (for example by pre-delivering a DRM license from the digital rights management server to the DDR unit) in the conditions defined by the content provider (the next time the user desires to do so).

Different billing options are available to the user: pay a fixed price per movie; pay a fixed price for an entire series during a season; monthly flat fee for unlimited movies, pay a price for the download only, (un)limited number of reproductions, or other possible methods. The fee collected for the playback may be shared with the content creator.

E. Playback

The user can then put the DDR unit in playback mode and gives instructions to listen or watch the multimedia file. The titles downloaded on the DDR unit appear in a menu displayed on the restitution device. Additional titles not selected by the user, but recommended by the system, can also be downloaded and displayed in the menu.

During the playback, commands can be sent at all time to the DDR unit through an infrared remote control.
Once the multimedia data have been played back and/or have expired, they can be deleted from the DDR unit, thus triggering new data to be potentially transmitted to the DDR unit.

F. Distribution Systems

The current invention is configurable for a plurality of systems. In one alternative embodiment, the content owner provides an original multimedia files in a digital format to the provider as well as eventually additional information describing said multimedia data such as title, category, etc. The provider will then encode them in a format compatible with the DDR units and encrypt the files for protection against sniffing, tampering or altering (320). DRM permission data are also encapsulated before the encoded data are stored. A seeding algorithm is then used to distribute these files on the network. The seeding algorithm will for example ensure there are enough copies of a particular title on the network before making it available for selection; it will ensure the redundancy of the more popular content is higher than the less popular content; it will ensure there is a predetermined number of copies of a title among the DDR units that share a same proxy server, etc. A new entry corresponding to the encoded multimedia data is entered in the catalog server (350).

The availability of high capacity drives enables the DDR units to store many files and be another potential source of data for other DDR units as often as possible, thus making the method described hereby a reality.

In another embodiment, as soon as a DDR unit is connected to the network, it uploads its latest status to the dispatch server and joins the sub-network already formed by the DDR units already connected.

In another embodiment, once a movie has been played back, the user will rate the movie either on the website described earlier or with the remote control (buttons 950). The rating of each movie enables the system to learn what each user might like in order to generate recommendations and/or pre-download titles that were not directly selected by the user but match the user's interests. These recommendations are based on the user's interest for specific kinds of titles (such as action or romance) and on the availability of certain titles in the DDR network, e.g. the files that match the user's criteria and are present on the highest number of other DDR units (preferably sharing the same proxy server), or the files that can be transmitted relatively fast or relatively efficiently will be recommended first.

G. Security

It is the intent of the present invention to fully respect the copyright of the content owners and enable a secure method to sell and distribute quality digital multimedia data.

The data, command, and status signals between the different DDR units are always encrypted.

The different DDR units form a closed loop that uses a complex handshake mechanism to accept new entrants on the network. An identification procedure, based on an exchange of public and private keys, permits the dispatch server to constantly monitor any attempts to break into the network.

An industry recognized digital rights management (DRM) method based on Microsoft Windows Media Player 9 or similar allows the distribution of the multimedia files to other PC or consumer electronic devices like portable players.

An invisible watermark can also be added to the images to avoid and track down the distribution of illegal recordings on Digital Video Recorders (DVR). Each time a DDR unit user is watching the multimedia data and/or copying them to a portable player, they are notified a watermark is transparently added to the images that are being viewed.

H. Use of the DDR Unit in Data Retrieval Mode

The DDR unit can also be used as a “download assistant” (or “data bank”) to facilitate the download of large files to a PC or any other device. A user who agrees to pay for this feature receives a software application for their device that enables the user to send to the dispatch server the address of a big file the user wants to download. The dispatch server will then locate and download the large file to the DDR unit and will send a message to the user when the file is available for direct transfer to the PC or consumer electronics device. It will enable users to download files from congested servers or slow remote locations on the Internet in a more convenient way since the bandwidth of an extremely fast server (e.g. a dispatch server) can be used. It is for example an ideal solution with portable video players that can use the DDR unit as a “docking station” that download large multimedia files for them that can later be transferred to the player.

The software tools to use the DDR unit as a “Download Assistant” can accept to transfer files from a FTP server, an HTTP URL location or a file-sharing program. A filter is installed on the dispatch server to avoid the transfer of copyrighted or illegal material.

I. Scalability

A single title is available in different quality whether the user desires a low-, medium- or high-definition resolution on the restitution device. A low quality is for example enough for online classes or TV shows; a higher resolution can be used for movies.

Different sound files are available for a single title. The user will therefore be able to choose the quality of the sound they want (whether or not they plan to use a standard stereo TV or a complete home theater system) as well as the language the user requires. The playback mechanism of the DDR unit is able to synchronize and recombine the sound file with the picture in different formats. This will allow the DDR unit network to carry less files than if the sound and picture files were mixed together. It will ease the international expansion of a DDR unit network since only one large picture file will be used in conjunction with different languages files (that are much smaller than the picture files).

J. One-to-One Advertising

Commercials can be inserted in the multimedia files downloaded by the user. The provider described in section II. A. is able to lower the cost of the different titles they are offering by inserting commercials before, during, or after the multimedia presentation. The choice is given to the customer to accept commercials (default) or not (if the user accepts to pay a minimal additional premium fee).

The advantage of the DDR unit system is that the ads can be customized for each user based on the user's profile, history of the downloaded titles, special event or special promotion, preferences previously defined, demographics or geographic location, answers to online surveys on the website described in section II. A, or other similar information that may be transmitted from outside the system. This will enable a real-time, one-to-one advertising method that has never been available before. Current advertisements on television are bulk advertisements that force a mass of consumer to watch all the ads (rather than focusing on a particular demographic user segment). An example of this method would be the insertion of commercials announcing the opening of a new local store: the advertisements would only be sent to customers living in the same neighborhood or town.

This is also applicable to the insertion of advertisements for future movies such as previews for a movie from the same studio but currently available in theaters only.

Another embodiment would be to enable other websites to track the behavior of an owner of a DDR unit (for example by sharing or exchanging Internet “cookies”) on their site. Advertisements that match their latest Internet searches (such as through a search engine like Google.com) or topics browsed on those websites would then be offered to the user.

K. Details of the Processes

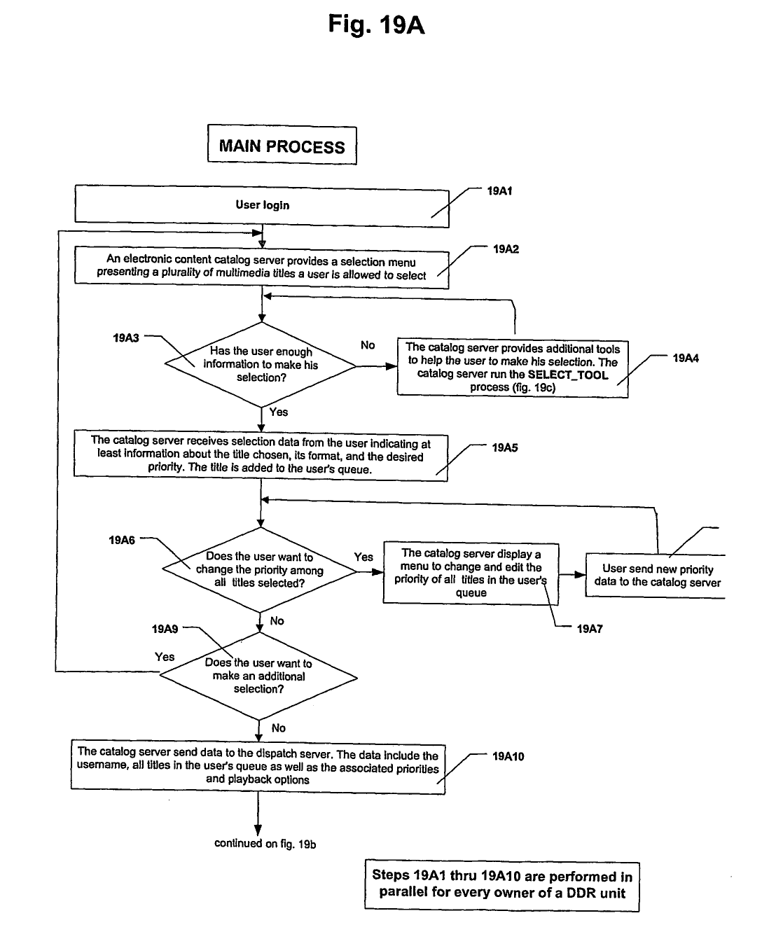

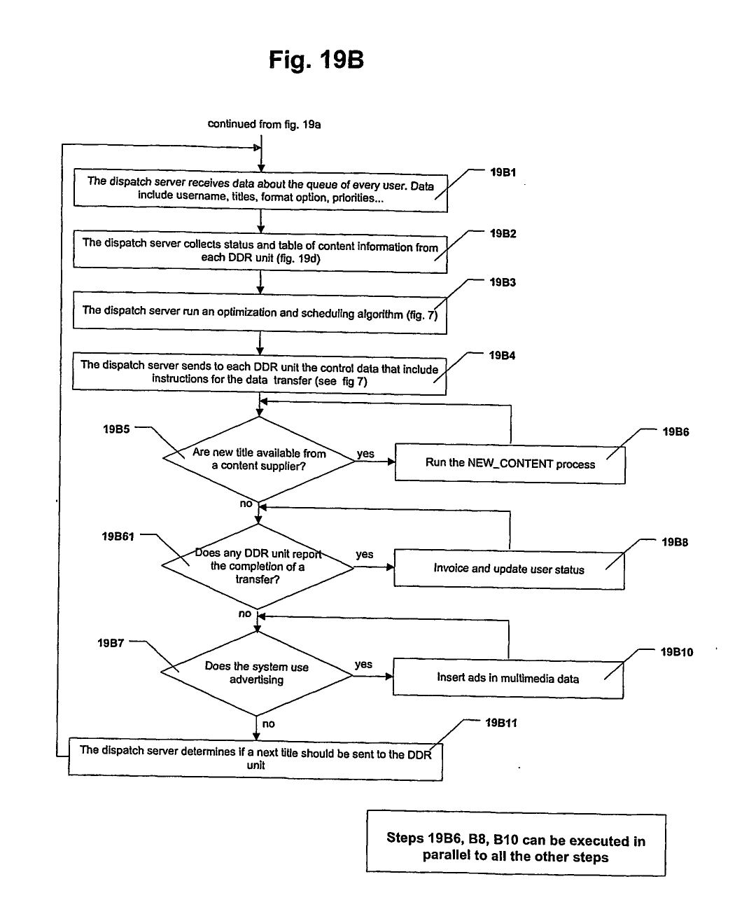

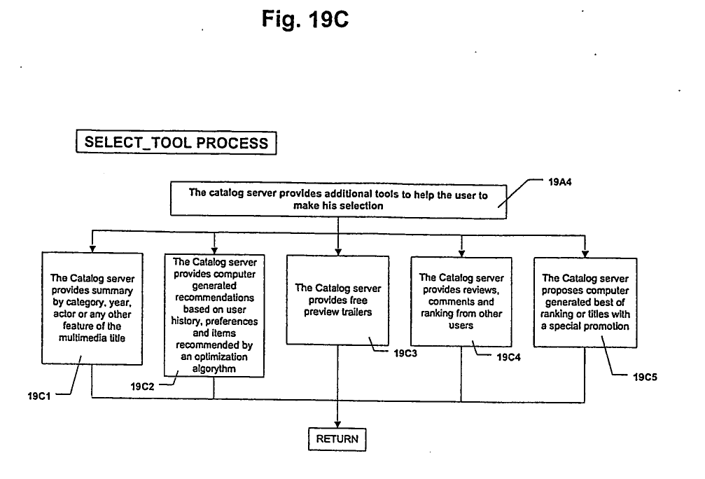

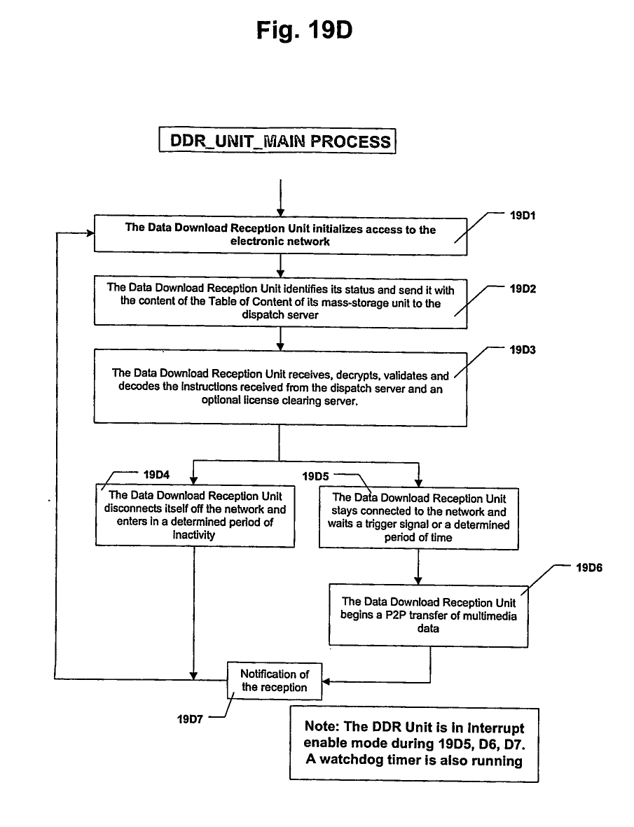

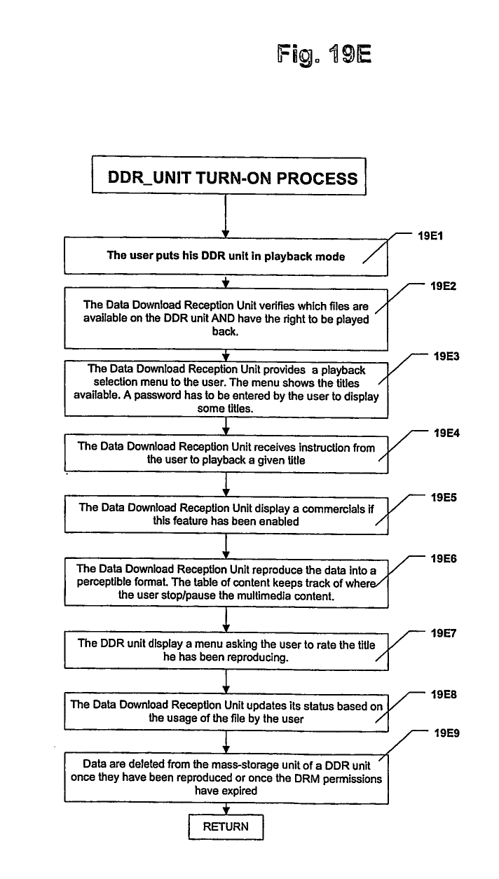

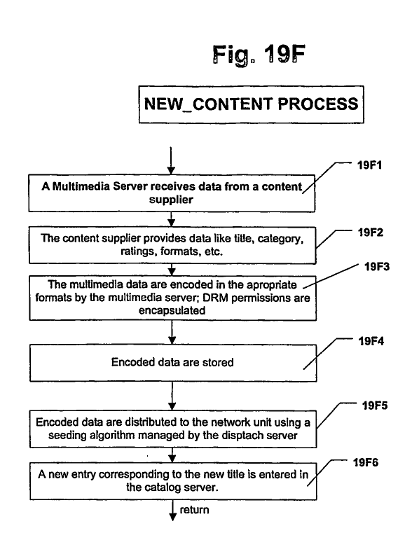

FIGS. 19A through 19F illustrate possible embodiments of the various component functions of this one embodiment of the present invention. There are five separate process describe the individual components as illustrated in FIG. 3. These processes are:
The “MAIN” process (as illustrated in FIGS. 19A and 19B), which describes the steps and operations performed by the servers of the system as well as the interactions between the elements of the system including the users;
The “SELECT TOOL” process (as illustrated in FIG. 19C) that describes in more detail how the titles can be selected;
The “DDR UNIT MAIN” process (as illustrated in FIG. 19D) that describes one way the DDR unit can operate and its internal operations;
The “DDR UNIT TURN ON” process (as illustrated in FIG. 19E) that describes one embodiment of the playback operations;
The “NEW CONTENT” process (as illustrated in FIG. 19F) that describes how new content can be received and can be made available on the network.

It must be noted that the steps in the illustrations have been depicted in a serial manner to facilitate the comprehension of the processes. One skilled in the art will realize that with the availability of fast processors, “multi-thread” technologies, and other technological improvements in software and hardware will enable the DDR system to perform those steps in a parallel or near parallel manner. It is also understood multiple instances of these processes can co-exist and be run, independently or not, by one or more elements of the system.

Main Process (as Illustrated in FIGS. 19 A and B)

In the first step of this subprocess, a user logs into the system (step 19A1). An electronic content catalog server then provides the user, preferably electronically, with a selection menu that presents a plurality of multimedia titles that the user is allowed to select (step 19A2). Next, in step 19A3, the process verifies the user has the appropriate information to make their selection. If more information are required, the catalog server can run the SELECT TOOL process (described in FIG. 19C) in order to provide additional tools to help the user to make a selection (step 19A4). This process can be repeated in a loop by returning to step 19A3 until the user has enough information and makes their selection, then the process continues to step 19A5.

Data corresponding to the user's selection are then received by the catalog server (step 19A5). These data include at least one way of uniquely identifying the selected item such as title, format chosen, filename, or other like data. The selected title is automatically added to the personal queue of this user. The process continues next to step 19A6, where the system provides the user with the option to change the priorities of the titles in the queue. If the user decides to change priorities, the catalog server provides a menu to the user to edit the priorities in step 19A7, then data highlighting the changes in the queue can be sent back to the catalog server (step 19A8), and the loop returns to step 19A6. If at step 19A6, it is determined that the user does not want to change the priorities, the process continues to step 19A9, where the system then verifies if the user wants to make an additional selection. If at step 19A9 the user decides to make an additional selection, the process returns to step 19A2 to repeat the loop. If at step 19A9 the user does not want to make any additional selections, the system moves to step 19A10.

In step 19A10, the catalog server sends data representing the queue and priorities of a user of the system to the dispatch server. Steps 19A1 through 19A10 can be performed in a parallel or substantially parallel manner for additional users of DDR units, for example in step 19A10, the catalog server sends data representing the queues and priorities of a plurality of users.)

In step 19B1, the data representing the selections and priorities of each user are gathered and optionally aggregated by the dispatch server.

At this stage of the process, the dispatch server will also start gathering data from the DDR units. As represented in step 19B2, several DDR units can transmit data representing their status and their table of content that are received by the dispatch server.

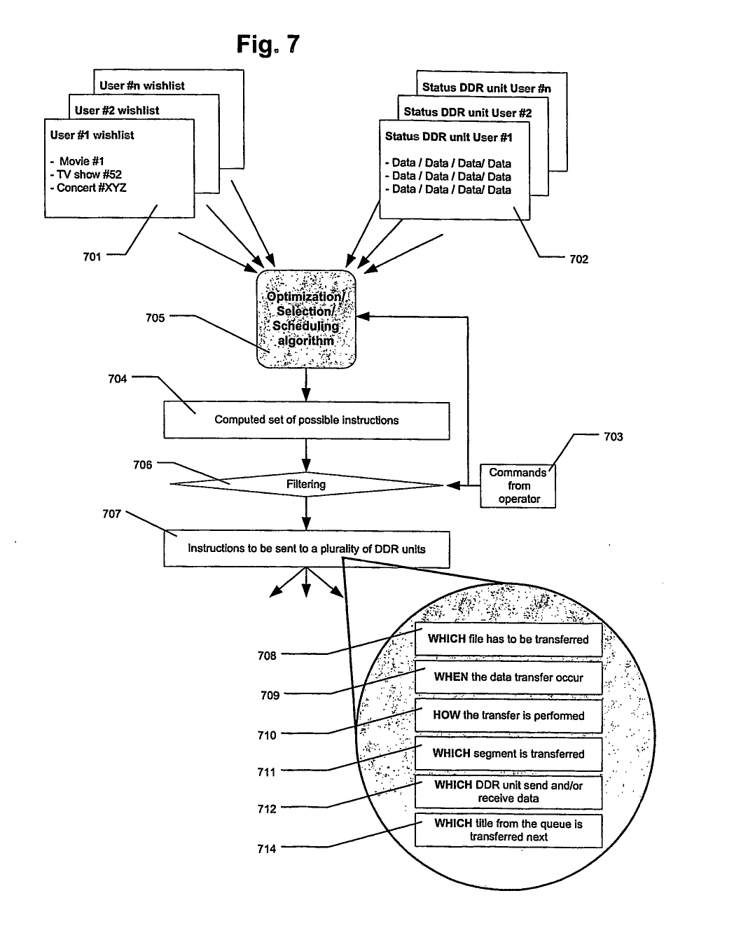

In step 19B3, the dispatch server then runs an algorithm (one embodiment of this algorithm is illustrated in FIG. 7) in order to be able to give the instructions the DDR units need to perform the transfer of multimedia data, preferably in an optimum manner for a given network situation. The output instructions for the data transfers are then sent to each DDR unit (step 19B4).

Steps 19B5 through 19B10 are secondary functions that can be performed by the dispatch server in differing order. One skilled in the art will realize that these steps, along with the other steps of the various processes of the present invention, can be performed in many different orders, or concurrently, to achieve the same or substantially similar results. The steps of this process, and the other process disclosed by the present invention, are presented in this order merely for illustrative purposes only.

At step 19B5, the dispatch server verifies if new multimedia content is available from a content producer. If it is true, the process moves to step 19B6 where the NEW CONTENT process (as illustrated in FIG. 19F) is run before returning to step 19B5.

When at step 19B5 the process determines that no new titles are available from the content supplier, the process moves to step 19B61, where the dispatch server then verifies if a DDR unit is reporting the completion of a transfer. If it is true, the process continues to step 19B8, and the dispatch server can update the user's history and the status of the associated title in the user's queue. A procedure can also be started at the same step to invoice the user and/or the content producer of the downloaded title, for example through an optional billing server. After completing step 19B8, the system returns to step 19B61.

If no DDR unit is reporting the completion of a transfer, the process then moves from step 19B61 to step 19B7, where the dispatch server optionally verifies if advertising is an option enabled by the operator of the system. If the answer to this question is yes, the dispatch servers takes the appropriate actions to insert commercials in the multimedia data (step 19B10), and then the process returns to step 19B7. This loop is repeated until the dispatch server, at step 19B7, determines no additional commercials have to be inserted and continues to step 19B11.

The dispatch server, at step 19B11, verifies if another title can be sent to a DDR unit. The process then returns to step 19B1 to perform other transfers.

Select Tool Process (FIG. 19C)

The SELECT TOOL process, as illustrated in FIG. 19C, can be used to provide additional tools to help a user to make the selection of a title. In one embodiment of the present invention, the catalog server in step 19A4 runs the SELECT TOOL process.

The first option that the catalog server presents to the user is represented by step 19C1.

The catalog server provides the user a summary by genre, actor or any other feature of the multimedia titles. Grouping the items by category facilitates the selection of a title by the user.

The second option that the catalog server can present the user is represented by step 19C2. The catalog server provides computer generated recommendations matching the user's interests. These recommendations can be based on the known preferences of a user, the previous title(s) the user has previously selected, or title(s) positively rated by the user in the past.

The third option that the catalog server can present to the user through the SELECT TOOL process is represented by step 19C3. The catalog server proposes free trailers to the user giving the user a preview of an item the user is interested to watch.

A fourth option the catalog server can present to the user is shown in step 19C4. The catalog server provides reviews, comments, rankings and feedback from other users.

A fifth option that the catalog server can present to the user is shown in step 19C5. The catalog server proposes computer generated “best of” rankings or titles corresponding to a special promotion.

Every time one of these options is chosen by the user, and the step(s) has been performed, the process returns to the MAIN process (step 19A3). The SELECT TOOL process is then repeated until the user has received enough information to make a selection of a title and the process continues to step 19A5.

DDR Unit Main Process (FIG. 19D)

The DDR UNIT MAIN PROCESS, as illustrated in FIG. 19D, is a process that can be performed internally in a loop (steps 19D1 to step 19D7) by a DDR unit once the DDR unit has been powered on. This loop can be interrupted at any time if necessary (for example when the DDR unit is put in playback mode by the user and launches the DDR UNIT TURN-ON process.)

The first step of this process is performed by the DDR unit that initializes the access to the electronic network (step 19D1) and joins the peer-to-peer network created by all the other connected DDR units. The DDR unit then compiles information about its status and the table of content of its mass-storage unit and sends these information to the dispatch server in step 19D2. The DDR unit receives in return instructions data from the dispatch server (step 19D3). These instructions can be decrypted, validated, and decoded by the DDR unit during this step. The DDR unit then takes a decision to perform step 19D4 or step 19D5 based on the decoded instructions.

The first option, as indicated by step 19D4, is that if no data transfers are planned, the DDR unit enters in idle mode for a determined period of time before returning to the beginning of the process (step 19D1.)

The section option, as indicated by step 19D5, is that if a data transfer is requested, the DDR unit waits for a signal or a determined period of time to then move to step 19D6, and start transferring the multimedia data optionally in a peer-to-peer manner. The data transfer process ends once the data transfer is completed with an optional notification sent to the network (step 19D7). The process then returns to step 19D1. It must be noted that the period of time specified in steps 19D4 and 19D5 can be null.

DDR Unit Turn-On Process (FIG. 19E)

The DDR UNIT TUN-ON process, as illustrated in FIG. 19E, starts when the user interrupts the DDR UNIT MAIN process by putting the DDR unit in playback mode (step 19E1) if the user desires to watch the multimedia data. The next step is step 19E2 where the DDR unit then verifies which files have been received on the DDR unit and are available for playback for this user. The process then moves to step 19E3, where a playback menu is then displayed, for example on the restitution device, to enable the user to select which file the user wants to watch. A password optionally has to be entered before the content can be played. At step 19E4, the instructions to play a particular title are given by the user (for example via a remote control) and received by the DDR unit.

At the next step (19E5), commercials may then be displayed if this is a feature that has been enabled by the operator of the DDR network. The chosen title is then played back by the DDR unit and watched by the end-user (step 19E6). The title is played back in accordance to DRM permissions associated with said tile, which have for example been earlier received from a digital rights management server. Playback commands from the user can also be received during step 19E6 such as pause, rewind, and fast-forward.

At the end of the reproduction of the title, the DDR unit may optionally ask the user to provide some feedback on the title watched and asks the user to rate the title in a rating menu (step 19E7). In the next step (19E8), the DDR unit then updates its status based on what the user has done with the file in step 19E6.

If the optional DRM permissions for a particular title have expired or if the user gives instructions to do so, the multimedia data corresponding to said particular title are deleted from the mass-storage unit of the DDR unit at step 19E9. The DDR UNIT TURN-ON process then exits and returns to the step of the DDR UNIT MAIN process, either where the DDR UNIT MAIN process was interrupted, or to a predetermined step in the DDR UNIT process. The DDR UNIT TURN-ON process can be then accessed again if the user wants to play another title.

New Content Process (FIG. 19 F)

The NEW CONTENT process can be run at step 19B6 when it is determined that new titles are available from a content supplier. A multimedia server receives content from a content supplier (step 19F1) which may then provide in step 19F2 information describing the content (such as category, rating, and format) that can be used to select or advertise the content in a catalog.

The multimedia data are encoded in the appropriate formats by the multimedia server, and optionally DRM permissions are encoded as well, at step 19F3. The multimedia data received are then encoded (step 19F3) in the appropriate format with encapsulated DRM permissions. These encoded data are then stored in step 19F4.

A seeding algorithm is then used to distribute the encoded data on the network formed by the DDR units and/or one or more mass-storage servers (step 19F5). A new entry corresponding to the new received content is then added in the catalog server (step 19F6), making the content available for selection.

This process then ends, and returns to the MAIN process at step 19B5. Different instances of the NEW CONTENT process can run in parallel to load and encode different titles on the network at the same time.

III. Additional Features

A. Continuous Device-to-Device Upload/Download

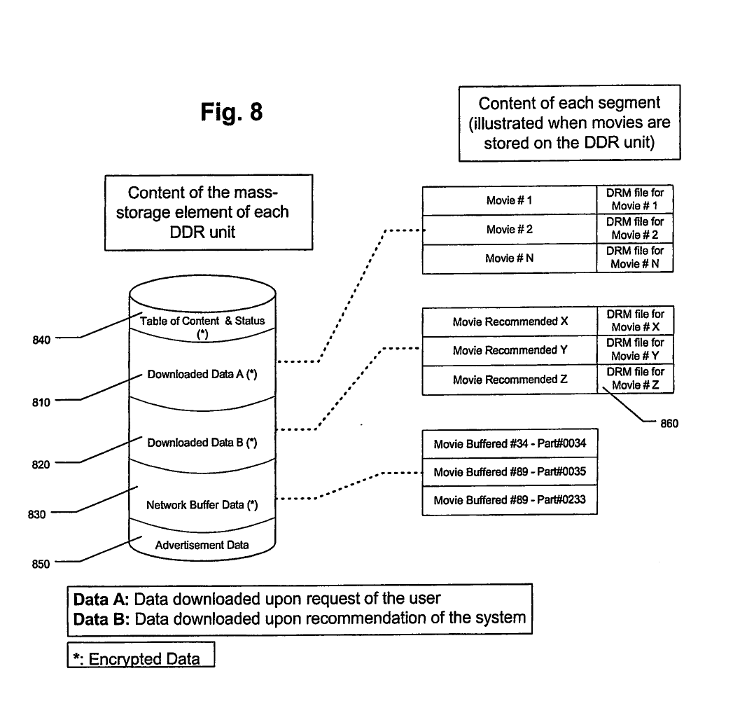

Each DDR unit is preferably always switched on and connected to the network formed by the different DDR units. Data are continuously transferred IN and OUT of the DDR unit to download content to the DDR unit of a first party OR upload content to the DDR unit of other parties. Each DDR unit therefore contains different kinds of data (FIG. 8):

1) Data downloaded upon request of the user (810), whether these data are already fully or partially downloaded. These data are visible in the user's menu and are always encrypted.

2) Data downloaded upon recommendation of the system (820), whether these data are already fully or partially downloaded. These data are visible in another section of the user's menu and are always encrypted.

3) Buffer data downloaded upon request of the dispatch server (830) to ensure there are enough copies of the data in the network to guarantee a quick distribution to all the users. These data are not visible to the user and are encrypted. An entire multimedia product is preferably never entirely buffered on one device to ensure there is no tampering temptation for the user.

4) Advertisement or announcement data (850) are also available. The data are not visible to the user and are preferably not encrypted. These advertisement data are preferably separated from the peer-to-peer data so that an update of the advertisements does not force peer-to-peer data to be re-seeded.

A table of contents (840) containing a description of the content of the DDR unit and the latest status of the DDR unit is also available on the mass-storage element of each DDR unit and can optionally be communicated on a regular basis to the network.

A specific digital rights management authorization file (860) may be associated with each multimedia title fully downloaded on the DDR unit.

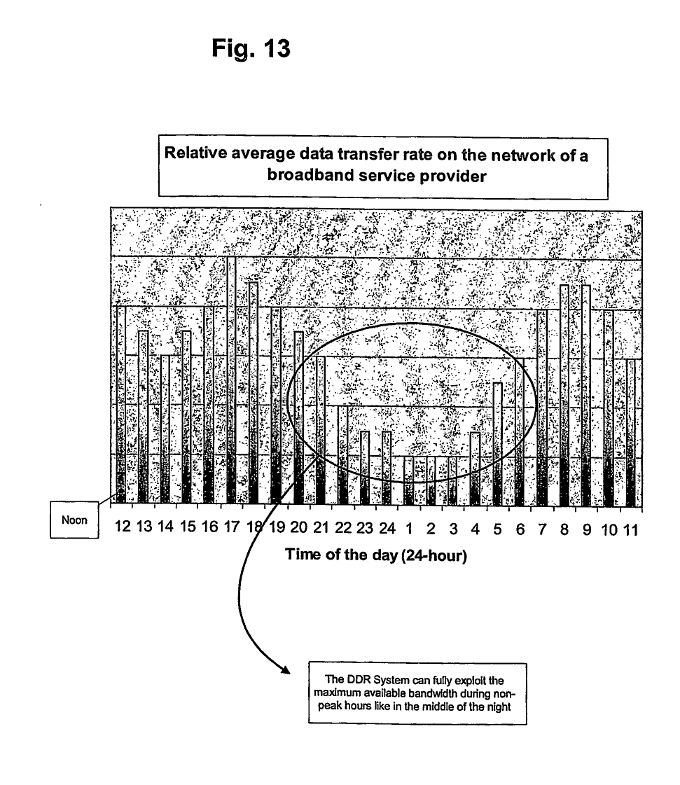

Each DDR unit is a potential source or sink of data for another DDR unit. By being powered on by default and preferably connected continuously to the network, each DDR unit can take advantage of the high bandwidth available during the low network activity periods of the day e.g. during the night, see FIG. 13.

B. File Management

The dispatch server is in charge of managing the multimedia files spread and stored across the multiple DDR units on the network. The files with the highest demand must for example be available in a large number of DDR units, new titles must be replicated when they are released or some files may need to be distributed more quickly than others (such as sporting events).

The present invention, optionally through the core engine of the DDR units, therefore maximizes the replication and download of specific titles per request of the dispatch server.

C. Selection of the Distribution and Optimization

A program runs on the dispatch server to continuously select, optimize and/or schedule the various transfers that occur in real-time. The program can be used to perform one of the following objectives:
maximization of the total amount of data transferred on the network in a given period
maximization of the user's satisfaction by ensuring the titles selected in priority are attempted to be transmitted first
maximization of the speed of the transmissions
maximization of the total number of titles fully transferred to the DDR units in a given period
minimization of the total cost of transferring the data on the network
ensure the transfers of data occur a time there is a substantially low transfer rate on the network
ensure the transfers of data occur between a restricted list of peers such as for example the peers belonging to an identical sub-network.
An exemplary embodiment of the selection/optimization/scheduling algorithm is illustrated in FIG. 7.

The inputs to the algorithm are the lists of titles and options (701) selected by each user (provided by the catalog server), the status and table of content (702) reported by each DDR unit and also some optional operator's commands (703). Statistical data about the system and/or data indicating the probable performance of transfers between two or more DDR units (such as the history of previous transfers) can also be used as input data in another embodiment (unillustrated).

The output variables of the optimization algorithm are control signals (707) that will be sent to each DDR unit. These signals comprise information about which file will be transferred (708), when (709) the transfer should occur (time of the day or special trigger signals), how (710) the transfer will occur (depending on the optimization model), which segment of a file (711) will be transferred, and which DDR units (712) will participate to the transfer (source or sink of data). The optimization algorithm monitors (705) the input data and can compute a plurality of combinations for the output variables (704) and assigns a score to each possibility. The combination with the highest score for a given selection method preferably specified by the operator (703) is chosen by an algorithm (706). The same algorithm is used for recommending titles (see section II. F): the title with the highest score for a given selection method in the users' wishlist is transferred first.

Different methods can be used as well as different combinations of these methods:
Selection Method #1: The number of sending DDR units that are on-line AND have a desired content must be above a determined level. One or more specific title from the queue is selected to be transferred first if it meets the condition above. Alternatively, the transfer of one or more specific title is scheduled or delayed to start at a time the condition above is met.
A particular case of this method is when the number of sending DDR units is high enough to utilize the total downstream bandwidth of a receiving DDR unit.
Selection Method #2: The number of receiving DDR units that have requested a particular content must be above a determined level. One or more specific title from the queue is selected to be transferred first if it meets the condition above. Alternatively, the transfer of one or more specific title is scheduled or delayed to start at a time the condition above is met.
Selection Method #3: The transfers between DDR units that are the closest to each other are started first. One or more specific title from the queue is selected to be transferred first if the title can be transferred from a DDR unit that is available AND considered as one of the closest to the receiving DDR unit. Alternatively, the transfer of one or more specific title is scheduled or delayed to start a time one or more of the sending DDR unit considered as one of the closest to one or more of the receiving DDR unit is available.
A particular case of this method is when the closest receiving/sending DDR units are considered close to each other if they are part of the same sub-network of an Internet Service Provider or cable network so that no transfers occur outside of the ISP or cable network.
Selection Method #4: The transfer of one or more specific title is scheduled or delayed until the number of users who have selected a specific title is above a determined level. One or more specific title from the queue is selected to be transferred first if it meets the condition above
Selection Method #5: Utilization of the proxy optimization method. One or more specific title from the queue is selected to be transferred first if it can be transferred by using the proxy optimization method. Alternatively the transfer of one or more specific title is scheduled or delayed to start at a time the proxy optimization method can be used. This method can be combined with method #1 or #2 and/or with a selection of the one or more most efficient proxy server that can be used for a determined transfer.
Selection Method #6: IP multicasting/IP broadcasting. One or more specific title from the queue is selected to be transferred first if it can be transferred thru IP multicasting/broadcasting. Alternatively the transfer of one or more specific title is scheduled or delayed to start at a time a higher number of receiving DDR units can use IP multicasting/broadcasting to transfer the data.
Selection Method #7: User satisfaction. Titles with the highest possible ranking in the queue of a plurality of users are transferred first to maximize user's satisfaction.
Selection Method #8: One or more specific titles from the queue are selected to be transferred first if it enables a lower number of peers to stay inactive (not transferring data).

D. Maximization of the Distribution by Sharing Proxy Servers

The dispatch server is able to manage the transfer of a specific file to the DDR units that share a common proxy server (for example DDR units part of the same sub-network of an Internet Service Provider) in a very efficient way.

The dispatch server, having received data indicating a plurality of titles requested by a plurality of users, detects if a proxy optimization method can be used. It determines which are the units that are available or will be available for sending chunks of data through a cache server as well as the best time for doing so. The dispatch server then gives instructions to the DDR units to transfer the file in a peer-to-peer manner with multiple smaller pieces being transmitted directly through the proxy server of the receiving DDR units. Each time a portion of the file has been successfully cached on the proxy, at least one other receiving DDR unit download the cached segment from the proxy server (and not from another DDR unit as with standard transfers). This process is repeated with other chunks and other peers until the last chunk of data is cached and retrieved. In one embodiment, the data transfers will preferably be grouped by transfers of identical data to a plurality of DDR units that may share at least one common proxy server to further enhance the efficiency of said transfers.

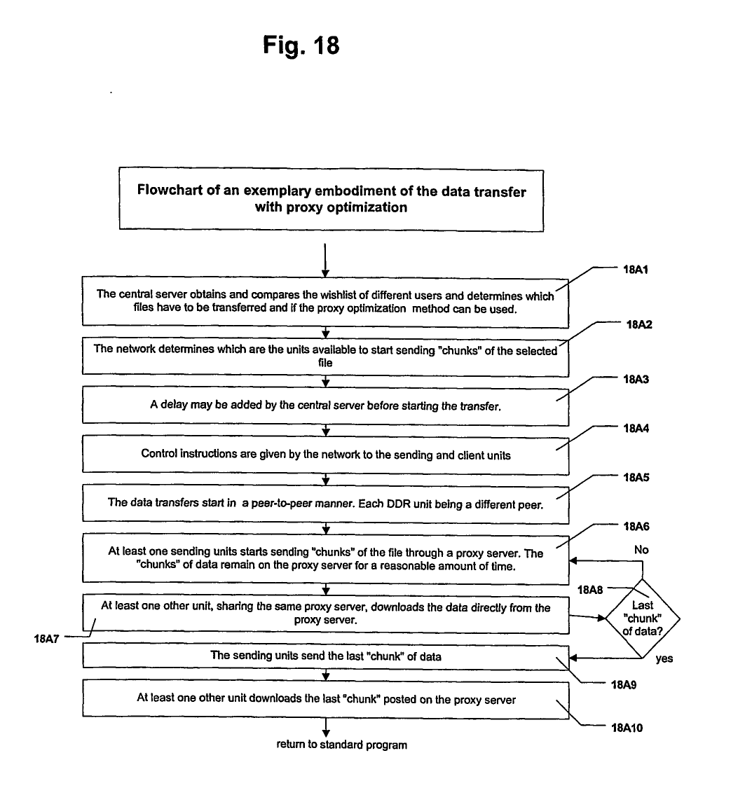

Functional Process (FIG. 18)

The proxy optimization method is a variant of the standard peer-to-peer transfer described above in FIG. 19D. This process starts at step 18A, and can be started after the dispatch server has collected data about the wishlist of a plurality of users and determines if such a proxy optimization method can be used. The dispatch server then determines which are the units that are available or will be available for sending the chunks of data (step 18A2) through a cache server as well as optionally the best time for doing so. A delay may optionally be added to wait for more DDR units become available (step 18A3). In step 18A4, control instructions are then given by the dispatch server so that the DDR units can start transferring data in a peer-to-peer manner in step 18A5. In step 18A6, at least one sending unit starts sending chunks of data through the proxy server and the chunks of data remain on the proxy server for a reasonable and/or pre-determined period of time. In step 18A7, at least one of the receiving DDR units sharing the same proxy server then downloads the cached data chunks directly from the proxy server before continuing to step 18A8. At step 18A8, it is determined if the next data chunk is the last chunk that has to be downloaded. If no, the process returns to step 18A6. If at step 18A8 the next chunk that has to be downloaded is the last one, the process continues to step 18A9. At step 18A9, the last chunk of data is therefore sent and cached by at least a DDR unit before being downloaded, in step 18A10, by at least one of the receiving DDR units. The proxy optimization process then ends and the program returns to the DDR UNIT MAIN process in step 19D7.

The benefits of this system are numerous and are crucial for transferring large multimedia files such as movies or video:
1) The speed of the connection between the proxy server and the receiving DDR unit is extremely fast as they are close along the same network, below a gateway to the rest of the Internet or other larger network.
2) The bandwidth between the receiving DDR unit and the proxy server is cheap. Other peer-to-peer systems do not focus on proxy sharing and download data from peers out of the network, using the backbone connection to the Internet or other larger network where bandwidth connections are more expensive.
3) This system enables “many-to-many” or “one-to-many” (also called “peer-to-multi-peer” or “P2MP”) peer-to-peer connections that solve the problem of the asymmetry of the bandwidth of most of the broadband connections (as disclosed in section III.E); at the same time, more peers can receive the desired content over a period of time.
4) This method can be used at a large scale since a majority of the Internet service providers use proxy servers to improve the efficiency of their systems (for example through caching).

Creating a queue that contains multimedia titles selected by a user as well as scheduling these transfers in order to use the proxy optimization method as often as possible is therefore one aspect of the system and method disclosed in this present application. These aspects of the present invention overcome the deficiencies of the present art as described below.

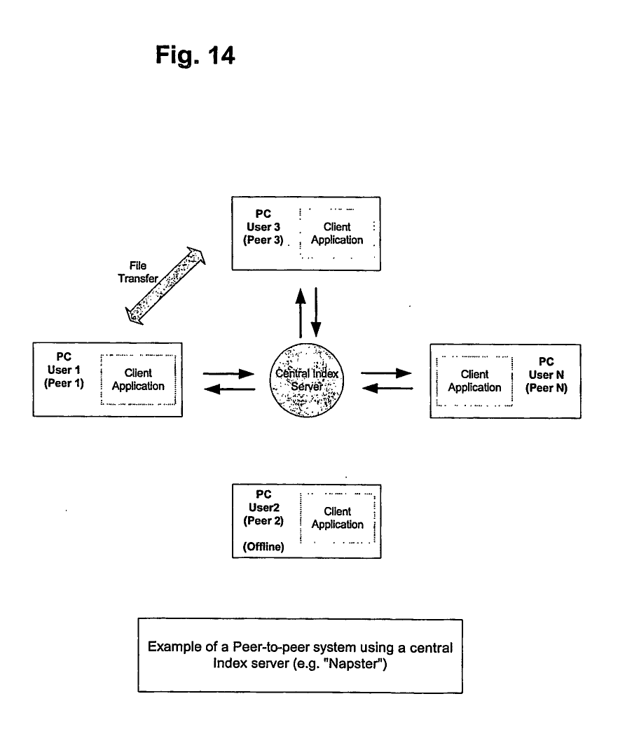

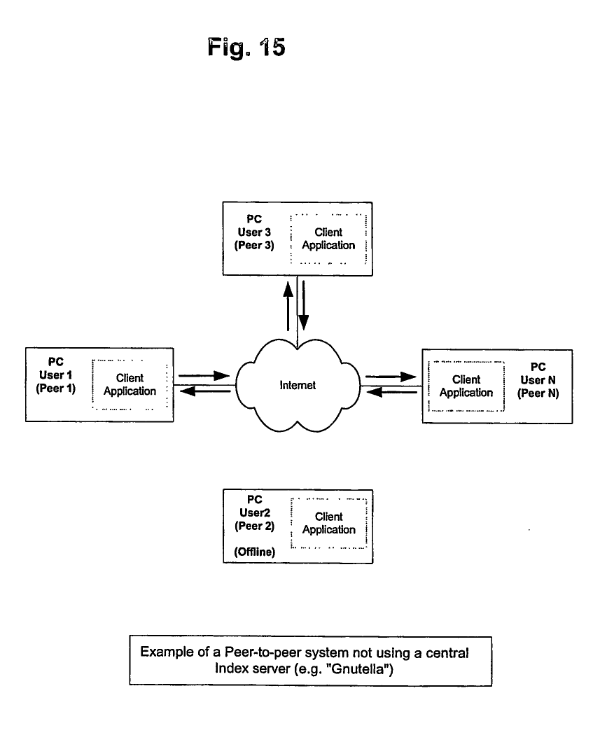

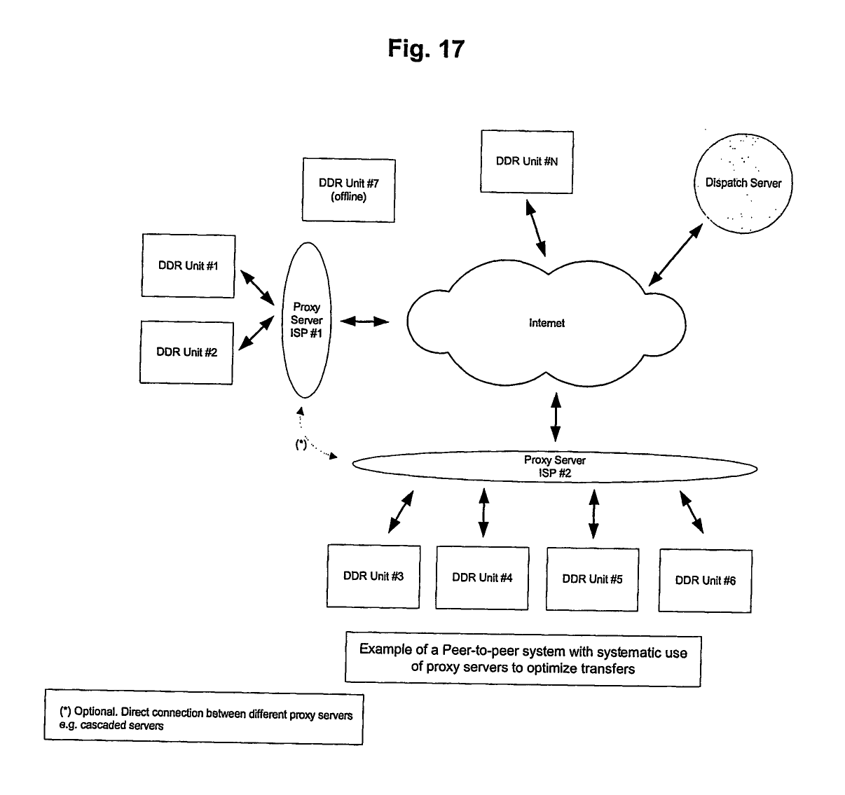

An efficient peer-to-peer network (as represented in FIG. 17), which includes proxy servers and multiple peers, can therefore be used instead of inefficient systems as described in FIG. 14 or 15:
1) Users #4, #5 and #6 (respectively owners of DDR unit #4, #5 and #6) have selected movie “EFG” (movie “EFG” is added to their wishlist) and desire to have it delivered to their DDR unit.
2) The dispatch server knows the closest peers that have movie “EFG” available are peers #3 and #N. No other peers in the network have movie “EFG” available in this example.
3) Peer #3 and #N are contacted and Peer #4 starts receiving segments of movie “EFG” from Peer #3 and #N. The transfer is configured to force an upload of the data thru proxy server ISP#2 that will cache each segment of the file.
4) Since the dispatch server knows peer #5 and #6 desire to receive the same movie AND share the same proxy server as peer #4, the proxy optimization method described above can be used. Peer #5 and #6 download each segment of “EFG” from the proxy, each time a new segment is available on this proxy.
5) A “many-to-many” peer-to-peer connection is therefore created between peers #3 and #N (sending DDR units) and peers #4, #5 and #6 (receiving DDR units), creating a kind of proxy to multi-device download.

The dispatch server (or in another embodiment the sending DDR unit) manages to split a large file in multiple segments, forcing the sending DDR unit to upload a segment of a file through a known proxy server, and then sending the information each DDR unit requires to download the file from said proxy server, such as filename, address of the originating DDR unit, etc. A new segment is sent each time a previous segment has been successfully received. It is therefore an iterative process that will stop when the last segment is received. An optional method can utilize the hyper text transfer protocol (HTTP) to overcome some problems of this method such as firewalls and equivalent servers. The proxy servers from an Internet service provider will generally be used by this non-public proxy server method however open public proxy servers (or any server caching files on an electronic network) can additionally be used. Another possible embodiment would be to use this proxy server method with files directly coming from an originating server and not only a DDR unit.

This method is key to the system described in this application since it is known in the multimedia industry that more than 65% of the on-demand requests are requests for new titles just released from movie studios. The present invention therefore dramatically facilitates a rapid distribution of these new titles.

A table, as illustrated in FIG. 20A, is maintained in the reception DDR unit or in the dispatch server with information showing the access time and/or performance of each DDR unit to reach each proxy server that can potentially be used. This table enables the system to choose which proxy server is the most appropriate to transfer a file to a particular DDR unit or group of DDR units.

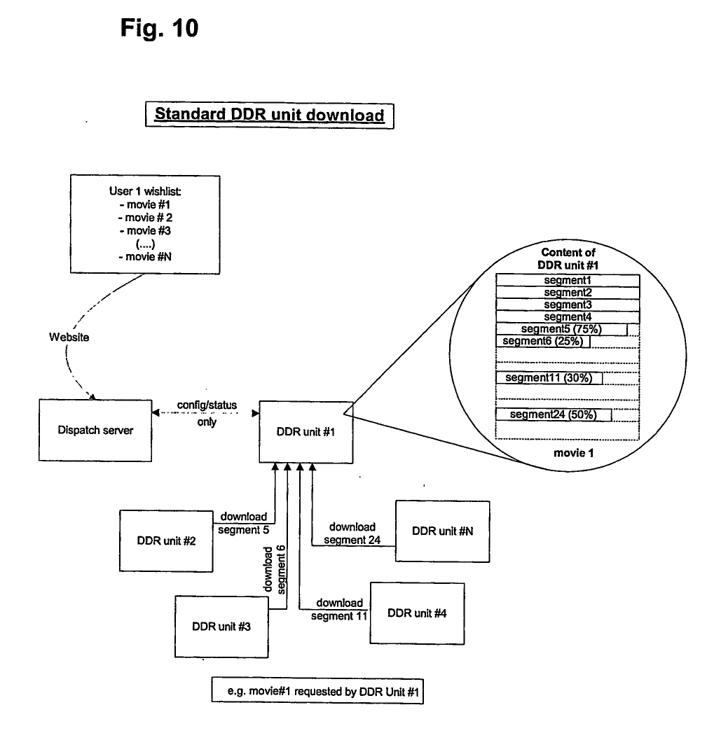

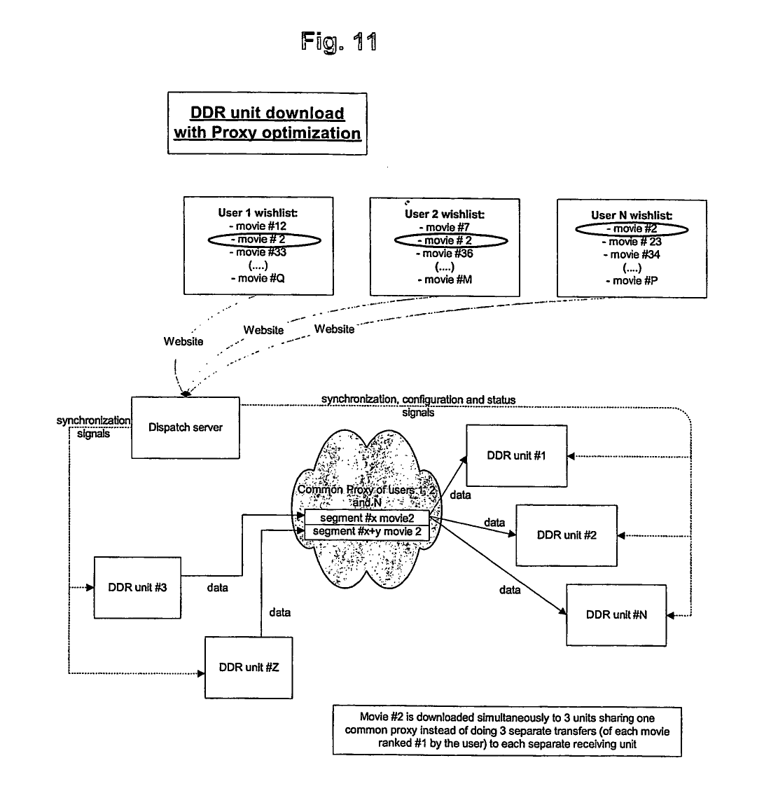

The dispatch server also uses this method to maximize the title distribution. A comparison is given in FIGS. 10 and 11: instead of starting three device-to-device downloads with three different titles, all in #1 position in the user's whishlist, the system can decide to do a proxy-to-multi-devices download that will maximize the number of movies transferred in a given amount of time. The method disclosed in the present invention demonstrates the benefits of prompting users towards establishing a wishlist of titles they want to download. The titles are not necessarily provided to the users in the serial order they have defined; the dispatch server can decide to transfer a particular title (714) with a slightly lower priority if it enables the system to utilize an optimization method such as described above.

E. Network Saturation

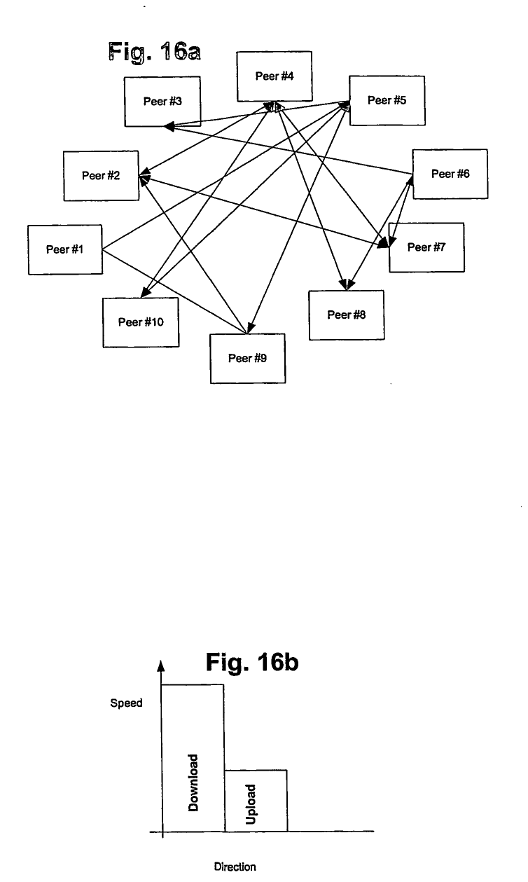

The majority of the broadband service providers use an asymmetric method to enable their subscribers to connect to the Internet (for example DSL or cable modems). In order to maximize the speed offered to their users, the download speed (downstream speed) of these systems largely exceeds the upload speed (upstream speed), sometimes up to a factor of 300% (as indicated in FIG. 16b). In normal mode, it is not a problem for the end-users of these providers since most of them connect to the Internet to retrieve (download) information for example from the web rather than to push (upload) the same information. In a peer-to-peer network, this method is however a major limitation that slows down the average transfer speed.

If the majority of the files transferred are small, such as MP3s, songs, short video clips or software, it is not a major disadvantage: the transfers are performed in a short period of time thus enabling a peer to be quickly available for another upload.

But if the majority of the files are video, high-definition movies, or large files in general that have to be transmitted on a regular basis, the transfers between the peers take more time and there is quickly a saturation in the upstream direction and the number of online peers that are available for upload tend to drop quickly below a critical level as too many of these peers are busy uploading data and cannot be considered as available for other transfers.

In standard peer-to-peer systems that do not use any kind of proxy optimization, the upstream direction will be saturated first. With the proxy optimization of the present invention, saturation will only occur at a later stage, closer to the maximum downstream speed.

F. Other

A timer is also included in the core of the DDR unit that enables the DDR unit to start releasing specific titles not before a determined time. This determined time can correspond to the time the title is made publicly available through another distribution channel such as cable television. This feature enables the DDR unit to pre-load multimedia data before the content provider decides to make them available for the public. This feature is used to ensure there are enough copies of a new release in the DDR unit network to enable the users to easily download a new title at the time the title is just made available. The present invention thus can address the high-demand for a new title in the 1-2 weeks that follows its release.

This feature also enables the method of using a DDR unit as a personal TV receiver over an electronic network. A TV show can be for example loaded in advance on a DDR unit but the user will not be able to watch it before the official time it is broadcast for viewing on the TV. A specific protection scheme combined with a timer indeed prevents the user from watching the multimedia title before its official broadcast on the air; this enables users who only have an Internet connection to watch programs at the same time as normal cable TV users would do. This method gives a new distribution channel to the providers of such programs.

This pre-loading can be useful for TV shows. If a user subscribes to watch the entire series, the next episode will be downloaded as soon as the previous one is viewed. But with the possibility for the movie studio to strictly make sure the next episode is not available before it is released on the air.

Another option that can further enhance the delivery of content by using the method described above is to establish a connection between the dispatch server and the server of the access provider used for network management. Most of these network management servers are in charge of limiting the maximum bandwidth of the broadband connection of their customers; for example most of the cable modems are limited today to 750 kilobytes/second (kps.)

A connection between the dispatch server and the network server of the access provider could therefore enable the transfer to go above the maximum modem transfer rate during some time of the day e.g. night. Such a deal with access service providers is another possibility for speeding up the delivery of the data.

G. Profiling

The website described in section II. A. can give the choice to a user of the system to use different profiles. These profiles are practical for a user if the user wants to create different configurations specific to one of the user's interests (e.g. profile#1 for sport, profile#2 for movies, etc.). It can also be used when different people access the same DDR unit to watch titles or receive files (e.g. profile#1 for children, profile#2 for parents, etc.). Each profile can benefit from the same feature as an individual user does (e.g. recommendation, history browsing, etc.).

Each profile can be password protected as described hereabove, therefore enabling different individuals to keep a private list of downloaded titles. The password can be entered with the remote control before watching a title or transferring data.

The official owner of a DDR unit can be billed for all the profiles coupled to the user's box (e.g. a family) or each profile can be billed separately (e.g. two roommates). The choice is also given to the owner to allow each profile to order different titles up to an explicit limit.

The official owner is also able to assign some restrictions to the possible titles a user can browse in the catalog, download or watch (e.g. restriction to use the DDR unit more than an amount of minutes or hours per day, restrict the use of the DDR unit after a specific time of the day, etc.).

This feature allows for example a very strict parental control on the titles played back by children.

IV. Optional Embodiments

The DDR system can be integrated in different other consumer electronics devices that will benefit from the advantages the connection to the DDR unit network can bring. The DDR system can be built-in as a standalone block in a consumer electronic device or can be embedded and built with other components on the board (method similar to an Intellectual Property Block).

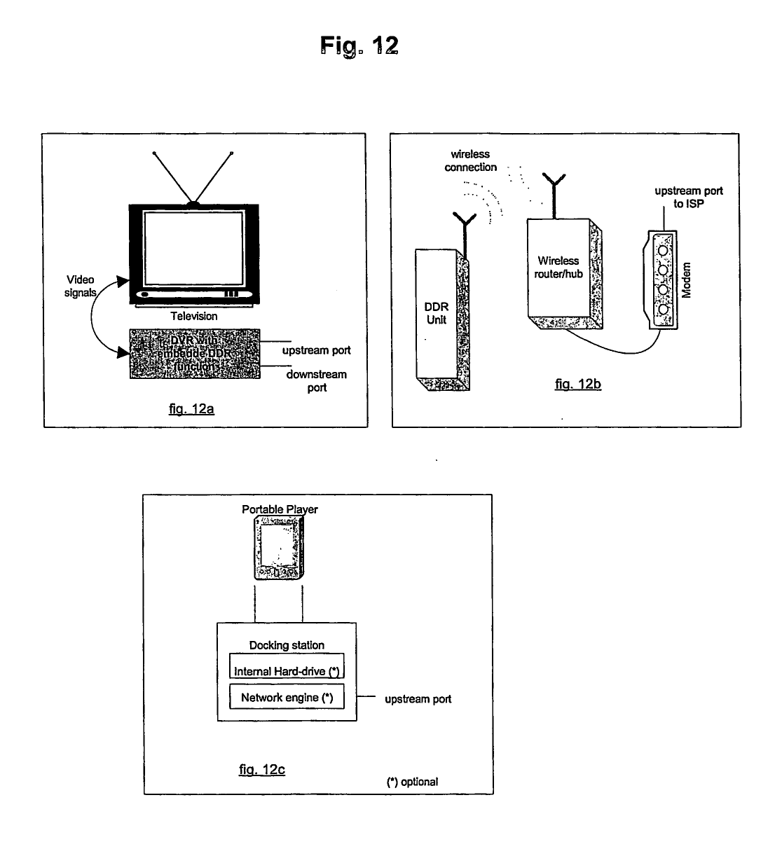

These optional embodiments are not intended as limiting the present invention to a range of embodiments. They merely intend to demonstrate the wide variety of potential applications of the present invention, and would assist one skilled in the art in implementing the present invention across an even wider variety of platforms and formats. These other embodiments are described in FIG. 12 and are disclosed as follows.

A. DVD Players, DVRs and Televisions (FIG. 12A)

The DDR unit can be embedded in a TV, in a DVD Player or in a DVR (Digital Video Recorders). These devices can share the same video output (and the same mass-storage unit in the case of the DVR). Extra network or configuration port will need to be added as well.

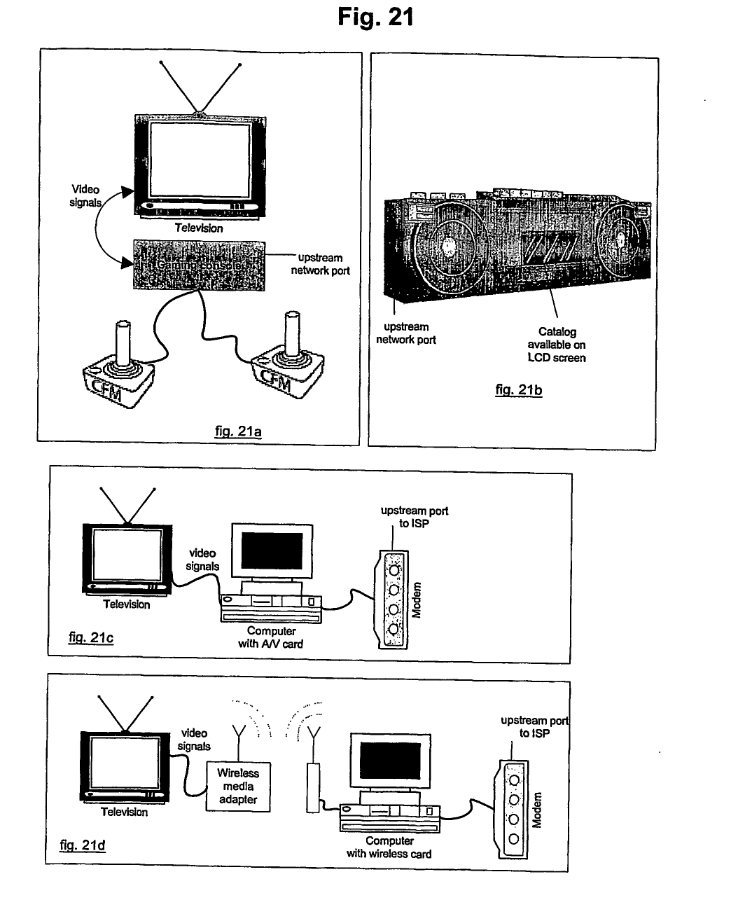

B. Gaming Consoles (FIG. 21A)

Some gaming consoles already have a network connection. By increasing the size of its internal mass-storage unit and adding a multimedia decoder, the game console can easily support a DDR system.

C. Wireless Systems (FIG. 12B)

The DDR unit as described earlier can be connected by a wireless connection to either the upstream port or downstream port. An equivalent wireless transmitter is necessary in the apparatus providing the network access point and eventually in the consumer electronic device or PC hooked up downstream.

D. Cradle and Docking Stations for Portable Player (FIG. 12C)

As disclosed above, the DDR unit can be used as a docking station for portable multimedia players. A further embodiment of this model also exists with “embedded” implementation of the DDR concept when the internal storage unit and multimedia decoder of a portable player can be reused to perform the functions described in this patent. The only requirement to make this application compliant with the DDR unit system is to include a controller to the network that enables the portable player to be recognized by the DDR network.

E. Stereo Player (FIG. 21B)

An additional embodiment of the present invention is a stereo player that only supports audio playback. The core of the DDR system is embedded in the stereo player thus enabling the user to download songs using the DDR system and play them on the stereo system.

F. Embedded Software DDR Core in PC (FIGS. 21C and 21D)

A PC connected to the broadband network can also be used to receive and distribute data files from the DDR network directly to a Personal Computer. A computer can indeed emulate the DDR system function and therefore constitute an additional source or sink of data.

G. Combined Method with Real-Time Multimedia-on-Demand

Another embodiment of the present invention is to combine the system and method described in the present invention with a real-time multimedia-on-demand system. The DDR system can be utilized to help real-time multimedia-on-demand systems provide the streaming data to end-users.

### ADVANTAGES OF THE INVENTION

The previously described versions of the present invention have many advantages over the existing art. The benefits of the present invention and the problems it solves can be divided into several categories.

First, the present invention enables a system to download data from a party to another party in a much more convenient way than what exists today. Data are downloaded in a secure manner. Since the DDR unit is a distinct entity from the other devices, a user will be better protected from external attacks from the Internet than if they were directly downloading the data. There is no need for the user to leave the user's computer turned on for a long time when downloading data; the DDR unit thus completely isolates the user from risks like hackers, virus, data and identity theft on the user's PC, or other cybercrimes.

Data can be downloaded continuously. Since the DDR unit is “always on” and the download of the data is done independently of the other devices, the DDR unit can download data at all times, continuously, throughout the day, whether the other devices (like the PC) are turned on or not. This will enable the user to transfer data smoothly and with a good average transfer speed since the DDR unit can exploit the full bandwidth of the network during non-peak hours (e.g. night, see FIG. 13).

Data can be downloaded at very high-speed. An algorithm can be integrated in the DDR unit and the dispatch server that is able to optimize transfers between the proxy servers of the different DDR units (see section III. D.). This optimization method is used as often as possible by carefully selecting the files to be transferred in a user's priority queue. The DDR units are also able to find the fastest nodes (usually the closest other DDR units in the network) that can transfer data. This optimization method results in minimal load for the backbone of the access service provider (e.g. ISP) and gives an extremely fast download speed to the end-users.

Many different types of data can be downloaded. The DDR unit can be used to transfer multimedia data from different on-demand service providers or it can be used to facilitate the transfer of standard files in FTP, HTTP, professional intranet, or file-sharing utilities. The data can be used for immediate playback or they can be transferred to a PC/portable multimedia player.

Second, the present invention allows multimedia data to be distributed in a manner superior to the existing art. Multimedia data are distributed in a very secure method for the parties supplying the content. The closed network formed by the DDR units, combined with a strong encryption mechanism and an embedded DRM method, is used to guarantee to the content owners that the content will not be tampered, altered or used in other conditions than agreed with the user.

Multimedia data can be transferred at a very low cost. The DDR units are interconnected together to form a closed sub-network and an algorithm can enable the DDR units to move multimedia data to/from each other without the intervention of an expensive central file server. There is no need for the operators to buy expensive streaming servers, complex routers or high-speed modulators. This results in a much to cheaper Multimedia-on-Demand solution and extremely low operating costs. For example, since there no necessity to maintain expensive delivery networks (including additional servers, bandwidth capacity and cabling), on-demand service providers will be able charge lower monthly network subscription fees to their customers, thus liberating them of the tyranny of monthly bills, especially if they do not watch anything during that month.

Users can have access to image and sound in a higher definition. Since data can be transferred most, if not all the time, bigger multimedia files can be distributed than with other on-demand systems over electronic networks and therefore the resolution and quality of the multimedia files can be much better than with the real-time “streaming” multimedia providers that must lower the resolution of the movies to decrease bandwidth usage.

Many more users can have access to on-demand multimedia data than with the current on-demand services. The DDR system can be used over a simple, existing, network infrastructure like the Internet. The only requirement to have access to the DDR system is to have a DDR unit and a broadband connection. In comparison, other services require satellite dishes, set-top-box receivers, digital tuners, or other expensive subscription plans. They also focus on broadcasting popular new releases, and neglecting others, as a limited number of movies can be delivered at the same time.

A much more convenient choice is given to the users to choose the titles they want. State-of-the-art selection tools are given to the user and will help the user to make the selection of the titles they want to watch.

Many more potential viewers can be attracted by releases from many more content providers. Since the DDR unit system can be easily deployed worldwide, it will attract a very large number of content providers. These providers will have access to a very large customer base and the users will have access to an unprecedented selection. For example, a user from California could be interested in multimedia data released by an Australian or Canadian television station. Nothing exists today to let the user know that these releases exist and may be of high interest for the user. Nothing exists today to let the Australian or Canadian Televisions know that there might be a viewer for their content in California. The DDR system will therefore foster the encounter of buyers and sellers on the multimedia content market. Content provided by individuals could also be made available under some specific conditions.

Third, the method of distribution of the present invention provides many advantages to users interested in on-demand multimedia services. The present invention discloses a manner that reconciles personal computers and television. The user can benefit from the comfort of watching multimedia titles on a TV (such benefits as a larger screen, excellent resolution, comfort of the living room) and benefit from the ease of choosing these titles on the web via a PC (such benefits as better search tools).

The present invention discloses a system that can be totally portable. A solution exists whether the upstream port to the network is in the same room as the restitution device or not. Multiple DDR units and multiple base stations can be added to the system to be used in different rooms of a residence or other building.

The present invention offers unmatched tools for the selection of on-demand multimedia titles. The user can pick which multimedia files they want to view prior to the download. This selection is done in a very user-friendly environment where several tools are potentially available to guide the user: ratings, preview, filters based on the user's own criteria. Such a level of “dynamic” user selection is impossible with traditional TV-based or satellite-based on-demand operators who focus on mass-distribution through a limited number of delivery channels. This selection feature is especially useful for some specific multimedia data like online classes that are more expensive and require more information/documentation than movies before being purchased.

The present invention is able to make recommendations based on the user's preferences or on what other users, with a similar profile, have chosen to download in the past. This custom “push” method is not available with traditional cable or satellite on-demand systems. One of the problems of these traditional providers is that their customers do not watch enough titles. By pre-loading and proposing titles that highly match the user's preferences, this method enables these providers to increase the number of titles viewed by a user and therefore takes advantage of the “impulsive” purchase behavior of consumers, especially when they are bored with the programs broadcasted on TV. The recommendation method of the DDR system also gives the possibility to small content providers to make their releases available and known to the broader public.

The present invention has an excellent international scalability. Only new language files must be made available to expand the DDR system outside of North America. Since the picture file can be reused and synchronized with new language files, there is no need to maintain redundant picture files for each foreign language.

The present invention allows for better management of the new releases and TV shows on-demand. Multimedia files can be pre-loaded to guarantee a user will receive a particular title at a particular time. This preloading ensures the best availability of new releases from movie studios to a user, something sometimes difficult to obtain with traditional on-demand systems that have difficulty satisfying the need of a large number of customers asking to watch the same file in the short period after its release. This preloading also enables a system equivalent to a television receiver over an electronic network (such as a cable or other broadband network) by pre-loading data and authorizing playback at the same time the program is broadcast on the air.

It must be noted that the present invention does not require that all the advantageous features and all the advantages be incorporated into every embodiment of the invention. It must be further noted that the present invention can be implemented across multiple varieties of networks. One skilled in the art will realize that the present invention, while described herein as applicable to cable systems and the Internet, can additionally be applicable to any type of network infrastructure, existing or future, including but not limited to satellite, radio transmissions, and wireless technologies. The present invention can be readily implemented across existing networks, in conjunction with current technologies on those networks. The invention further relates to a computer program for enabling a programmable device when executing said computer program to function as the data download reception unit with some or all the features disclosed herein.

### CONCLUSION

Although the present invention has been described in considerable detail with reference to certain versions thereof, other versions are possible. Therefore, the spirit and scope of the appended claims should not be limited to the description of the preferred versions contained herein.

The reader's attention is directed to all papers and documents which are filed concurrently with this specification and which are open to public inspection with this specification, and the contents of all such papers and documents are incorporated herein by reference.

All the features disclosed in this specimen, including any accompanying claim, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

1-156. (canceled)

157. A secure data transmission system, comprising:
a. a data download reception unit comprising:
i. a mass-storage unit;
ii. a data communications interface;
iii. an output interface;
iv. a chipset operatively connected to the mass-storage unit, data communications interface, and output interface;
b. a secure data transmission network comprising:
i. one or more dispatch servers;
ii. one or more electronic content catalog servers;
iii. one or more of said data download reception units;
c. software embedded in said data download reception unit, capable of:
i. identifying, connecting to, and authenticating with the servers of said secure data transmission network;
ii. identifying and connecting to one or more of said data download reception units on said secure data transmission network;
iii. sending data to and receiving data from the servers of said secure data transmission network;
iv. sending data to and receiving data from other data download reception units on said secure data transmission network; and
v. reproducing data into perceptible format.

158. The system of claim 157, said dispatch server further comprising software capable of controlling, scheduling, or optimizing the data transfers occurring on said secure data transmission network.

159. The system of claim 157, said secure data transmission network further comprising one or more additional servers, wherein said additional server comprise at least one of:
a. a multimedia server;
b. a mass storage server;
c. a billing server; and
d. a digital rights management server.

160. The system of claim 157, said data download reception unit further comprising:
a. data capable of being downloaded upon request; and
b. a table of contents.

161. The system of claim 157, said data download reception unit further comprising data duplicated and stored in a redundant manner across a plurality of other data download reception units, the redundancy of said data being controlled by said secure data transmission system.

162. The system of claim 161, wherein the redundancy for the data forming an item is determined by the popularity of the item.

163. The system of claim 157, said data download reception unit further comprising data capable of being downloaded, wherein said data comprise at least one of the following:
a. data transferred upon request of said secure data transmission network, said data being transparent to users;
b. data representing advertisements; or
c. data representing status information.

164. The system of claim 157, said data download reception unit further comprising means for being a potential source or sink of data capable of being downloaded between at least two data download reception units on said secure data transmission network.

165. The system of claim 157, said data download reception unit further comprising a timing mechanism operatively connected to said chipset, enabling at least one of:
a. said data download reception unit to remain turned on most of the time, or at all time;
b. said data download reception unit to communicate on a regular basis with said secure data transmission network.

166. The system of claim 157, said data download reception unit further comprising a mechanism operatively connected to said chipset, enabling said data download reception unit to accept to start one or more data transfers at a particular time, said particular time being determined by said secure data transmission network.

167. The system of claim 157, said secure data transmission network further comprising a mechanism operatively connected to said chipset to prevent a user of said data download reception unit from choosing from which source data are transferred from and to said user's data download reception unit.

168. The system of claim 157, further comprising one or more of said data download reception units capable of exchanging data among themselves through IP multicasting or IP broadcasting.

169. A data download reception unit, said data download reception comprising:
a. a mass-storage unit;
b. a data communications interface;
c. an output interface; and
d. a chipset operatively connected to the mass-storage unit, data communications interface, and output interface;
wherein said data download reception unit is capable of being connected to a secure data transmission network.

170. The system of claim 157, said data download reception unit being implemented as a system or an intellectual property block in a consumer electronic device, wherein:
a. said consumer electronic device may be characterized by its ability to boot up almost instantaneously; and
b. said consumer electronic device may comprise one or a combination of the following: a gaming console, a DVD-player, a DVD-recorder, a television, a set-top-box, a personal video recorder, a stereo player, a portable multimedia player, a multimedia adapter, an Internet media receiver, or peripheral devices for said consumer electronic device.

171. The system of claim 157, said data download reception unit being implemented on a personal computer, said personal computer being capable of emulating one or more functions of said data download reception unit.

172. The system of claim 157, wherein data transferred on said secure data transmission network forms multimedia content, wherein:
a. said multimedia content may be transferred in a compressed format;
a. said multimedia content represents existing or future multimedia releases; and
b. said multimedia content is individually or globally selectable.

173. The system of claim 157, wherein said secure data transmission network comprises one or more modules for encrypting some data transmissions.

174. The system of claim 157, said secure data transmission system further comprising
d. one or more proxy servers, wherein:
i. said proxy servers being capable of caching data;
ii. one or more nodes of said secure data transmission network being capable of transferring data to and from said proxy servers; and
iii. one or more data download reception units may be capable of exchanging data with one or more of said proxy servers at a substantially higher data rate than with the rest of said secure data transmission network.

175. The system of claim 174, said proxy servers further comprising at least one of:
a. a proxy server of an Internet service provider used by a plurality of said data download reception units capable of accessing said secure data transmission network through said Internet service provider;
b. a general-purpose Internet proxy server.

176. The system of claim 174, wherein said data download reception units are further made capable of transferring data cached by said proxy servers.

177. The system of claim 174, wherein said dispatch server is further capable of providing instructions to said data download reception units to enable said units to transfer data cached by said proxy servers.

178. The system of claim 157, said secure data transmission system further comprising means for:
d. providing a client node of said secure data transmission network with one or more download choices; and
e. receiving said client node's download selection.

179. The system of claim 178, wherein said download selection indicates one or more items a user of said client node desires to receive.

180. The system of claim 178, said secure data transmission system further comprising means for enabling, after receiving said download selection, said client node to create a user's queue with one or more items selected by user of said client node to transmit, if the number of said download selection is greater than one.

181. The system of claim 180, further comprising an electronic link to an equivalent of a DVD-by-mail rental user queue.

182. The system of claim 180, said secure data transmission system further comprising means for enabling said client node to establish a desired order for said one or more items in said user's queue.

183. The system of claim 178, said secure data transmission system further comprising means for performing step d. or e. at a substantially distinct moment than data transmission on said secure data transmission network.

184. The system of claim 157, said secure data transmission system further comprising means for:
a. storing said data on said data download reception unit while the amount of downloaded data stored on said data download reception unit does not exceed a predetermined limit; and
b. accepting data of another data transmission to said data download reception unit when the amount of downloaded data stored on said data download reception unit is less than a predetermined limit.

185. The system of claim 184, wherein said other data transmission has been enabled by said secure data transmission system or by a user of said secure data transmission system.

186. The system of claim 157, said secure data transmission system further comprising means for transmitting data formed by a plurality of independently transmittable segments, said segments being transmittable in a parallel and simultaneous manner to and from one or more client nodes of said secure data transmission network, and said segments capable of being reassembled by said client node.

187. The system of claim 186, wherein said client node comprises embedded software additionally capable of transmitting said segment to another client node as soon as said segment has been received on a client node.

188. The system of claim 157, said data download reception unit further comprising system required data, wherein said system required data are comprised of at least one of:
a. advertising data; data of downloads automatically recommended by said secure data transmission system for a user of said data download reception unit;
b. data forming other downloads, selectable by other nodes on said secure data transmission network, cached by said secure data transmission system on said data download reception unit;
c. digital rights management information;
d. and software or firmware.

189. The system of claim 157, said secure data transmission system further comprising means for charging a fee to a user of said secure data download reception unit for the reproduction or the transmission of said data.

190. The system of claim 157, wherein the reproduction of said data into perceptible format is further performed in accordance to permissions defined in said data's associated digital rights management information.

191. The system of claim 157, said secure data download reception unit further comprising means for deleting data of said data download reception unit upon request of a user of said data download reception unit, or once said data have been reproduced or have expired according to permissions defined in said data's associated digital rights management information.

192. The system of claim 157, wherein said data download reception unit further comprises means for transferring said data stored on said data reception unit to another electronic device, which may comprise a portable multimedia player or a digital media adapter, according to permissions defined in said data's associated digital rights management information.

193. The system of claim 157, said software embedded in said data download reception unit being capable of reproducing advertising data before, during, or after said data are reproduced into perceptible format.

194. The system of claim 159, said secure data transmission system further comprising means for customizing advertising data for one or more client nodes, said advertising data being electronically selected for one or more particular client nodes, the selection of said advertising being executed based on one or more of the following:
a. the profile of a user of said client node;
b. the preferences a user of said client node has previously defined;
c. the data previously downloaded to said client node;
d. a special promotion;
e. a special event; and
f. information about a user of said client transmitted to said secure data transmission system.

195. The system of claim 159, said billing server further comprising means for charging a fee to an advertiser for the reproduction of said advertiser's data.

196. The system of claim 157, said software embedded in said data download reception unit being further capable of attaching an electronic watermark to said data.

197. The system of claim 157, said secure data transmission system, further comprising means for preventing data transmitted to said data download reception unit from being reproduced into a perceptible format before a predetermined time, wherein said predetermined time may correspond to the time the same data are made publicly available through another distribution channel.

198. The system of claim 178, said secure data transmission system further comprising means for executing an optimization algorithm with data monitored by said secure data transmission system, wherein said algorithm enables said secure data transmission system to perform at least one of the following:
a. coordinating the transmissions of said data on said secure data transmission network;
b. determining the optimal method of performing the transmissions of said data on said secure data transmission network;
c. determining one or more originating data source nodes and one or more client nodes for said transmissions of said data over said secure data transmission system;
d. determining which download from said client node's download selection will be transmitted; and
e. determining which data or which segment of said data will be transmitted; wherein said means may comprise an additional module for repeating said optimization algorithm.

199. The system of claim 198, said secure data transmission system further comprising means for monitoring the download selection of one or more of said client nodes on said secure data transmission network.

200. The system of claim 198, said secure data transmission system further comprising means for monitoring at least one of:
a. the status and content of one or more of said data download reception unit on said secure data transmission network; or
b. statistical data about said secure data transmission network, wherein said statistical data may include reports on the history of said transmissions of said data between said nodes of said secure data transmission system.

201. The system of claim 198, said secure data transmission system further comprising means to provide at least one of the following conditions:
a. the number of data sources, which are online on said secure data transmission system and said data sources have a particular set of said data available for transfer is maximal or above a predetermined level;
b. the number of client nodes, which have requested one or more particular set of said data is maximal or above a predetermined level;
c. the transfer of said data can occur between nodes that are determined to have a relatively fast node to node transfer rate over said secure data transmission system;
d. the data can be transferred by using a proxy server;
e. the data can be transferred between client nodes by using an Internet protocol multicasting or Internet protocol broadcasting transfer; or
f. the number of nodes that are on-line on said secure data transmission system and are not transmitting data at a given time is minimal or below a predetermined level.

202. The system of claim 157, said secure data transmission system further comprising means for arranging the transmissions of said data by group of transfers of identical data to a plurality of client nodes, wherein said client nodes may be capable of sharing one or more proxy servers.

203. The system of claim 157, said secure data transmission system further comprising means for sending control information to said data download reception unit comprising at least one of:
a. data for coordinating the transmissions of said data over said secure data transmission system;
b. data indicating the method of performing the transmissions of said data;
c. data indicating one or more originating data source nodes and one or more client nodes for said transmissions of said data over said secure data transmission system; or
d. information indicating which data or which segment of said data will be transmitted.

204. The system of claim 159, said multimedia server further comprising embedded software capable of:
a. receiving multimedia content from a supplier; encoding said multimedia content into an appropriate format for said secure data transmission system, said appropriate format comprising a plurality of separately transmittable segments;
b. distributing said multimedia content over said secure data transmission system; and
c. cataloging said multimedia content for unique or global selection on said secure data transmission network, wherein cataloging said multimedia content for global selection may enable a creation of one or more multimedia channels.

205. The system of claim 204, wherein said distributed multimedia content further comprises at least one of the following associated elements:
a. digital rights management permissions;
b. advertisement content.

206. The system of claim 204, wherein said secure data transmission system comprises means for controlling said distribution by a seeding algorithm distributing said multimedia content in a redundant manner to said secure data transmission system, wherein said seeding algorithm ensures one or more of:
a. a minimum predetermined number of copies of said multimedia content on said secure data transmission system before making said multimedia content available for selection;
b. the redundancy of said multimedia content is determined by the popularity of said multimedia content; or
c. a predetermined number of copies of said multimedia content among client nodes of said secure data transmission system that share a proxy server.

207. The system of claim 204, further comprising means for automatically distributing said multimedia content globally selected every time new multimedia content globally selected is received.

208. A method of data transmission over a secure data transmission system comprising:
a. identifying and authenticating a client node connected to said secure data transmission system;
b. providing said client node with one or more download choices;
c. receiving said client node's download selection from said download choices; and
d. transmitting data representing said download selection to said client node over said secure data transmission network from one or more data sources operably connected to said secure data transmission network.

209. The method of claim 208, wherein step d. is further comprised by transmitting data representing said download selection to another client node over said secure data transmission system.

210. The method of claim 208, wherein said download selection indicates one or more items a user of said client node desires to receive.

211. The method of claim 208, said download selection further comprising after the step of receiving said download selection, the step of creating a queue with one or more items selected by said client node to transmit, if the number of said download selection is greater than one.

212. The method of claim 211, further comprising linking said queue to a DVD by mail rental system.

213. The method of claim 211, wherein said download selection further comprises a user of said client node's desired order for one or more items to be transmitted to said client node.

214. The method of claim 213, further comprising the step of providing a menu to enable a user of said client node to modify the desired order for said items selected to be transmitted.

215. The method of claim 208, wherein the download choices of step b. and the download selection of step c. are transmitted outside of the secure data transmission network.

216. The method of claim 208, wherein said data transmission of step d. is performed at a substantially distinct moment than steps a., b. or c., and said distinct moment may be determined by said secure data transmission system.

217. The method of claim 216, wherein said distinct moment ensures at least one of:
a. more data can be transmitted over said secure data transmission network in a determined period of time;
b. more data can be transferred to one client node of said secure data transmission network;
c. a higher number of client nodes or a higher number of data sources can participate to the transmission of said data;
d. the cost of transmitting said data on said secure data transmission network can be lowered; or
e. the transmissions of said data representing said download can occur at a time there is a substantially low transfer rate on said secure data transmission system.

218. The method of claim 208, further comprising:
a. storing said data representing said download selection on said client node while the amount of downloaded data stored on said client node does not exceed a predetermined limit; and
b. accepting data representing another of said download selection to said client node when the amount of downloaded data stored on said client node is less than a predetermined limit and said other download selection exist.

219. The method of claim 218, wherein said other download selection has been uniquely or globally enabled by said secure data transmission system or by one of said client nodes.

220. The method of claim 208, wherein said transmitted data are formed by a plurality of independently transmittable segments, said segments being transmittable in a parallel and simultaneous manner to and from one or more of said data sources over said secure data transmission system, and said segments capable of being reassembled by said client node.

221. The method of claim 220, wherein said segment can be additionally transmitted to another client node as soon as said segment has been received on a client node.

222. The method of claim 208, wherein step d. further comprises:
a. caching said data representing said download selection on at least one proxy server, said proxy server being selected by said secure data transmission system; and
b. enabling one or more of said client nodes to retrieve said cached data directly from said proxy server.

223. The method of claim 208, wherein step d. further comprises transmitting system required data, wherein said system required data are comprised of at least one of:
a. advertising data;
b. data of downloads automatically recommended by said secure data transmission system for said client node;
c. data forming other downloads, selectable by other nodes, cached by said secure data transmission system on said client node;
d. digital rights management information; or
e. software or firmware.

224. The method of claim 208, further comprising the step of:
e. reproducing said data transmitted to said client node into a perceptible format, upon request of a user of said client node and in accordance to said transmitted data's associated digital rights management information.

225. The method of claim 224, further comprising the step of:
f. charging a fee to said user of said client node for the reproduction or the transmission of said transmitted data.

226. The method of claim 224, further comprising deleting at least a portion of the transmitted data of said client node once said data have been reproduced or have expired according to permissions defined in said transmitted data's associated digital rights management information.

227. The method of claim 224, wherein reproducing said transmitted data further comprises transferring said data to another electronic device, according to permissions defined in said transmitted data's associated digital rights management information.

228. The method of claim 224, wherein step e. further comprises reproducing data comprising advertising before, during, or after said transmitted data are reproduced into perceptible format.

229. The method of claim 228, wherein said advertising data are customized for one or more client node, said advertising data being electronically selected for one or more particular client nodes, the selection of said advertising being executed based on one or more of the following:
a. the profile of a user of said client node;
b. the preferences a user of said client node has previously defined;
c. the data previously transmitted to said client node;
d. a special promotion;
e. a special event; or
f. information about a user of said client node transmitted to said secure data transmission system.

230. The method of claim 228, further comprising charging a fee to an advertiser for the reproduction of said advertiser's data, wherein said fee may satisfy at least one of the following:
a. said fee is used to lower a cost charged to said client node for the reproduction of said data transmitted to said client node;
b. said fee is shared with the creator of said reproduced data or the service provider providing network access to said client node.

231. The method of claim 224, wherein step e. further comprises attaching an electronic watermark to said data.

232. The method of claim 224, wherein step e. further comprises preventing said transmitted data from being reproduced into a perceptible format before a predetermined time, wherein said predetermined time may correspond to the time the same data are made publicly available through another distribution channel.

233. The method of claim 208, further comprising the steps of executing an optimization algorithm with data monitored by said secure data transmission system, wherein said algorithm enables said secure data transmission system to perform at least one of the following:
a. coordinating the transmissions of said data downloads;
b. determining the optimal method of performing the transmission of said data downloads;
c. determining which data source nodes will send and which client nodes will receive data;
d. determining which download from said client node's download selection will be transmitted; or
e. determining which data or which segment of said data download will be transmitted.

234. The method of claim 233, further comprising the step of monitoring the download selections of one or more of said client nodes on said secure data transmission system.

235. The method of claim 233, further comprising the step of monitoring at least one of:
a. the status and contents of one or more of said data sources or one or more of said client nodes on said secure data transmission system; or
b. statistical data about said secure data transmission network, wherein said statistical data may include reports on the history of said transmissions of said data downloads between said nodes of said secure data transmission system.

236. The method of claim 233, further comprising repeating the steps of claim 233.

237. The method of claim 233, wherein any of the steps of may be performed to provide one or more of the following conditions:
a. the number of source nodes, which are on-line on said secure data transmission system and said source nodes have a particular set of said data download available for transfer is maximal or above a predetermined level;
b. the number of client nodes, which have requested one or more particular set of said data downloads is maximal or above a predetermined level;
c. the transfer of said data downloads can occur between client nodes that are determined to have a relatively fast node to node transfer rate over said secure data transmission system;
d. the data download can be transferred by using a proxy server;
e. the data download can be transferred between nodes by using an Internet protocol multicasting or Internet protocol broadcasting transfer; and
f. the number of nodes that are online on said secure data transmission system and are not transmitting data at a given time is minimal or below a predetermined level.

238. The method of claim 233, wherein step b. further comprises consideration of at least one of:
a. a peer-to-peer transfer between a plurality of client nodes;
b. a transfer using a proxy server; or
c. a transfer using an Internet protocol multicasting or Internet protocol broadcasting method.

239. The method of claim 233, wherein said optimization algorithm facilitates one or more of the following:
a. maximization of the total amount of data transferred on said secure data transmission system within a determined period;
b. maximization of satisfaction of users of said client nodes by ensuring the downloads selected in priority by users of said client nodes are attempted to be transmitted first to said client node;
c. maximization of the speed of the transmissions of said data downloads on said secure data transmission system;
d. maximization of the total number of data downloads fully transmitted to said client nodes over a determined period of time;
e. minimization of the total cost of transferring said data downloads over said secure data transmission system;
f. the transmissions of said data representing said download selection can occur at a time there is a substantially low transfer rate on said secure data transmission system; or
g. the transmissions of said data representing said download selection can occur between a restricted list of nodes of said secure data transmission system.

240. The method of claim 208, wherein transmitting said data further comprises transmitting said data in a peer-to-peer manner between said client nodes from a plurality of data sources on said secure data transmission network, said client nodes being a potential source or sink of data to one or more of said client nodes.

241. The method of claim 208, wherein said secure data transmission system arranges the transmissions of said data download by group of transfers of identical data to a plurality of said client nodes.

242. The method of claim 208, wherein said download choices comprise multimedia content that may comprise:
a. existing or future multimedia releases; and
b. individually or globally selectable multimedia content.

243. A method of connecting a client node to a secure data transmission system comprising
a. accessing and authenticating to said secure data transmission system;
b. transferring control and status information between said client node and said secure data transmission system; and
c. transferring multimedia data from and to said secure data transmission system, wherein said multimedia data may comprise advertisement data or optional digital rights management permissions.

244. The method of claim 243, wherein said client node further comprises a table of contents which is transmittable to said secure data transmission system.

245. The method of claim 243, wherein said control information transferred further comprises at least one of:
a. data for coordinating the transfers of said multimedia data over said secure data transmission system;
b. data indicating the method of performing the transfers of said multimedia data over said secure data transmission system;
c. data indicating one or more originating data source nodes and one or more client nodes for said transfers of said multimedia data over said secure data transmission network; or
d. information indicating which segment of said multimedia data or which multimedia data from a group of distinct media data will be transferred.

246. The method of claim 243, wherein step c. further comprises the step of automatically transferring said multimedia data in accordance with optional priorities if:
a. said multimedia data form one or more multimedia content objects uniquely or globally selected in a queue; and
b. the amount of multimedia data stored on said client node, including multimedia data from previous optional data transfers, does not exceed a predetermined limit; and
c. said multimedia data were determined to be transferred.

247. The method of claim 243, wherein transmitting said multimedia data further comprises transmitting said multimedia data in a peer-to-peer manner on said secure data transmission system, said client nodes being a potential source or sink of data to one or more of said client nodes.

248. A method of delivering multimedia content over a secure data transmission network comprising:
a. receiving multimedia content from a supplier;
b. encoding said multimedia content into an appropriate format for said secure data transmission system, said appropriate format comprising a plurality of separately transmittable segments;
c. distributing said multimedia content over said secure data transmission system; and
d. cataloging said multimedia content for selection upon at least one feature of said multimedia content;
wherein:
i. step d. may be performed before step c.; and
ii. multimedia content may be cataloged in a global selection manner for creating multimedia channels on said data transmission network.

249. The method of claim 248, wherein step c. further comprises the step of performing a data transfer of said multimedia content to one or more client nodes authenticated and connected to said secure data transmission network if at least one of the following conditions is met:
a. said client nodes have globally or uniquely selected said multimedia content in a list;
b. the amount of multimedia content stored on said client nodes, including multimedia content from previous data transfers, if any, does not exceed a predetermined limit;
wherein:
i. priorities may affect said data transfer of said multimedia content; and
ii. said data transfer is performed at a later time for other client nodes if said other client nodes become accessible on said secure data transmission network and at least one of said conditions are still met.

250. The method of claim 249, wherein said data transfer is initiated by an electronic system.

251. The method of claim 249, wherein the steps of claim 249 are repeated when new multimedia content is received by said supplier.

252. The method of claim 248, wherein said secure data transmission system further comprises one or more data download reception units, said data download reception unit comprising means for being a potential source or sink of data of said multimedia content to one or more other said data download reception units.

253. The method of claim 248, further comprising the step of associating said multimedia content in a determined manner with one or more of the following:
a. one or more digital rights management permissions;
b. one or more advertisements; or
c. a fee.

254. The method of claim 248, wherein said distribution is controlled by a seeding algorithm to distribute said multimedia content in a redundant manner to said secure data transmission system, wherein the seeding algorithm ensures one or more of:
a. a minimum predetermined number of copies of said multimedia content on said secure data transmission system before making said multimedia content available for selection;
b. the redundancy of said multimedia content is determined by the popularity of said multimedia content; or
c. a predetermined number of copies of said multimedia content among client nodes of said secure data transmission system that share a proxy server.

255. A method for transferring data from one or more sources to a plurality of client nodes over a peer-to-peer network:
a. caching said data transmitted from said sources on at least one proxy server shared by one or more of said client nodes; and
b. enabling one or more of said client nodes to retrieve said cached data directly from said proxy server; wherein:
i. said client nodes may be capable of exchanging data with one or more of said proxy servers at a substantially higher data transfer rate than with the rest of said peer-to-peer network;
ii. said client nodes may be data download reception units; and
iii. said sources may be data download reception units.

256. The method of claim 255, wherein said client nodes are made capable of retrieving said data while said data remain on said proxy server.

257. The method of claim 255, wherein said proxy server is further comprised of at least one of the following:
a. a proxy server of an Internet service provider used by one or more of said client nodes to access said peer-to-peer network through said Internet service provider; or
b. a general-purpose Internet proxy server.

258. The method of claim 255, further comprising the step of said peer-to-peer network categorizing said client nodes by group of nodes sharing one or more common proxy servers.

259. The method of claim 255, further comprising the step of said peer-to-peer network arranging the transmission of said data by group of transfers of identical data to client nodes sharing one or more common proxy servers.

260. The method of claim 255, wherein said proxy server enables a many-to-many peer-to-peer connection between said data sources and said client nodes.

261. The method of claim 260, wherein said many-to-many peer-to-peer connection enables at least one of the following:
a. a higher number of said client nodes can receive a particular set of data on said peer-to-peer network over a determined period of time;
b. the number of said data sources required to transmit a particular set of data to a plurality of client nodes over a determined period of time can be lowered;
c. the amount of data transmitted in the upstream direction of said peer-to-peer network can be lowered;
d. more data can be transferred over said peer-to-peer network in a determined period of time;
e. more data can be transferred to one client node of said peer-to-peer network; or
f. the cost of transferring data on said peer-to-peer network can be lowered.

262. The method of claim 255, further comprising the preliminary step of analyzing one or more distinct data transfer queues.

263. A device for optimizing the transfer of data files on a peer-to-peer network comprising:
a. means for collecting the list of data files requested by a plurality of nodes of said peer-to-peer network;
b. means for executing an optimization program with data gathered by said peer-to-peer network and said collected lists of data files; and
c. means for arranging and executing the transfers of said data files in accordance to output instructions generated by said optimization program;
wherein said peer-to-peer network may comprise a BitTorrent type system or another equivalent system.

264. The device of claim 263, further comprising means for enabling said peer-to-peer network to gather data, wherein said gathered data comprise at least one of:
a. the status of one or more of said nodes of said peer-to-peer network;
b. the list of data, fully or partially, stored on said nodes of said peer-to-peer network;
c. data indicating the probable performance of transfers between two or more nodes of said peer-to-peer network;
d. statistical data about said peer-to-peer network; or
e. null data.

265. The device of claim 263, wherein said output instructions comprise at least one of:
a data for coordinating the transfers of said data files over said peer-to-peer network;
b. data indicating the method of performing the transmissions of said data files;
c. data indicating one or more originating data source nodes and one or more client nodes for said transfers of said data files over said peer-to-peer network; or
d. information indicating which data files or which segment of said data files will be transferred.

266. In a peer-to-peer network comprising a plurality of client nodes capable of transferring one or more multimedia content objects, a system for transferring at least one of said multimedia content objects comprising:
a. one or more of, or a combination of, the following modules:
i. a module suitable for monitoring a subset of said client nodes determined to receive one common multimedia content object; or
ii. a module suitable for monitoring a subset of said multimedia content objects determined to be received by one particular client nodes;
b. means for indicating to a subset of said clients nodes to transfer at least one particular multimedia content object at a determined moment, wherein:
i. said determined moment may correspond to the point in time a substantial number of said client nodes can transfer said particular multimedia content object; or
ii. said determined moment may correspond to a point in time a substantial number of said client nodes can transfer at least a portion of said particular multimedia content object through a common caching server;
c. a module suitable for transferring one or more of said multimedia content objects to one or more of said client nodes;
wherein said peer-to-peer network may comprise a BitTorrent system or an equivalent system.

267. The system of claim 266, further comprising one or more of, or a combination of, the following additional modules:
a. a module suitable for enabling at least one of said client nodes to queue a plurality of said multimedia content objects, possibly in a global manner, wherein one or more of said multimedia content objects queued may comprise a future publication;
b. a module suitable for determining when a transfer of one of said multimedia content objects start or stop, said module comprising an algorithm tracking storage space information;
c. a module suitable for automatically performing a transfer of one or more new multimedia content objects when one or more of said new multimedia content objects is published;
d. a module suitable for associating a priority of transfer with one or more of said multimedia content objects, wherein said priority may be related to a publication frequency;
e. a module suitable for associating a transfer of advertising or digital rights management content with a transfer of one or more of said multimedia content objects;
f. in a group of one or more multimedia content objects stored on a particular client node, a module suitable for determining which of said multimedia content objects stored is a source of data to one or more distinct client nodes;
g. a module suitable for maximizing the on-line availability of one or more of said client nodes, wherein said module may comprise a mechanism for maintaining one or more of said client nodes connected to said peer-to-peer network when one or more of said client nodes have terminated a data transfer;
h. a module suitable for performing an analysis over a determined period of time of the ratio between the amount of data transferred by one particular client nodes in the uplink direction and the amount of data transferred by said particular client node in the downlink direction;
i. a module suitable for enabling an electronic system to trigger or schedule a data transfer of one or more of said multimedia content objects with no human intervention;
j. a module suitable for distributing one or more data transfers of said multimedia content objects over a period of time and in accordance with user or system inputs.
